(19) United States
(12) Patent Application Publication
(10) Pub. No.: US 2023/0292011 A1
(43) Pub. Date: Sep. 14, 2023

(54) INFORMATION PROCESSING SYSTEM, IMAGE-CAPTURING DEVICE, AND DISPLAY METHOD

(71) Applicant: Koshiro Hori, Kanagawa (JP)

(72) Inventor: Koshiro Hori, Kanagawa (JP)

(73) Assignee: Ricoh Company, Ltd., Tokyo (JP)

(21) Appl. No.: 18/166,635

(22) Filed: Feb. 9, 2023

(30) Foreign Application Priority Data
Mar. 8, 2022 (JP) 2022-035333

(51) Int. Cl. H04N 23/698; H04N 5/262

(52) U.S. Cl. CPC H04N 23/698; H04N 5/2628

(57) ABSTRACT

An information processing system includes circuitry to detect one or more targets preset in a detection setting from a wide-angle image captured by an image-capturing device. In a case where a plurality of targets is detected from the wide-angle image, the circuitry generates a first image including the plurality of targets; and controls a communication terminal to display the first image.

### CROSS-REFERENCE TO RELATED APPLICATIONS

This patent application is based on and claims priority pursuant to 35 U.S.C. § 119(a) to Japanese Patent Application No. 2022-035333, filed on Mar. 8, 2022, in the Japan Patent Office, the entire disclosure of which is hereby incorporated by reference herein.

### BACKGROUND

### Technical Field

The present disclosure relates to an information processing system, an image-capturing device, and a display method.

### Related Art

In a telecommunication system of the related art, an image and audio are transmitted in real time from one site to one or more other sites, so that users at the remote places have a conference using the image and the audio. In such telecommunication, a device such as an electronic whiteboard is sometimes used.

With techniques of the related art, a portion including a speaker who is a participant participating in a conference at one site is clipped from an image. For example, such techniques include a system that performs face recognition and displays a close-up of a speaker from a spherical image.

### SUMMARY

In one aspect, an information processing system includes circuitry to detect one or more targets preset in a detection setting from a wide-angle image captured by an image-capturing device. In a case where a plurality of targets is detected from the wide-angle image, the circuitry generates a first image including the plurality of targets; and controls a communication terminal to display the first image.

In another aspect, an image-capturing device includes circuitry to capture a wide-angle image. In a case where a plurality of targets preset in a detection setting is detected from the wide-angle image, the circuitry generates a first image including the plurality of targets detected.

In another aspect, a display method includes detecting one or more targets preset in a detection setting from a wide-angle image captured by an image-capturing device; generating a first image including a plurality of targets in a case where the plurality of targets is detected from the wide-angle image; and controlling a communication terminal to display the first image.

### BRIEF DESCRIPTION OF THE DRAWINGS

A more complete appreciation of embodiments of the present disclosure and many of the attendant advantages and features thereof can be readily obtained and understood from the following detailed description with reference to the accompanying drawings, wherein:

FIG. 1 is a diagram illustrating an overview of creation of a record for storing a screen of an application (hereinafter, referred to as an app) executed during a teleconference together with a panoramic image of surroundings according to an embodiment of the present disclosure;

FIGS. 2A to 2C are diagrams illustrating an example of a generated panoramic image;

FIG. 3 is a diagram illustrating a configuration of a record creation system according to an embodiment of the present disclosure;

FIG. 4 is a diagram illustrating an example of a hardware configuration of an information processing system and a communication terminal;

FIG. 5 is a diagram illustrating an example of a hardware configuration of a meeting device;

FIGS. 6A and 6B are diagrams illustrating an example of an image-capturing range of the meeting device;

FIG. 7 is a diagram illustrating an example of a panoramic image and clipping of speaker images;

FIG. 8 is a diagram illustrating an example of a hardware configuration of an electronic whiteboard;

FIG. 9 is a block diagram illustrating a functional configuration, as individual blocks, of the communication terminal, the meeting device, and the information processing system of the record creation system according to an embodiment;

FIG. 10 is a diagram illustrating example items of information on a recorded video, stored in an information storage unit;

FIG. 11 is a diagram illustrating an example of conference information managed by a communication management unit;

FIG. 12 is a diagram illustrating an example of association information, associating a conference identifier (ID) and device identification information with each other, stored in an association information storage unit;

FIG. 13 is a diagram illustrating an example of account information stored in an account information storage unit;

FIG. 14 is a block diagram illustrating, as individual blocks, an example of a functional configuration of the electronic whiteboard;

FIG. 15 is a diagram illustrating an example of information such as the device identification information stored in a device information storage unit;

FIG. 16 is a diagram illustrating object information stored in an object information storage unit;

FIG. 17 is a diagram illustrating an example of an initial screen displayed by an information recording app operating on the communication terminal after login;

FIG. 18 is a diagram illustrating an example of a recording setting screen displayed by the information recording app;

FIG. 19 is a diagram illustrating an example of a recording-in-progress screen displayed by the information recording app during recording;

FIG. 20 is a diagram illustrating an example of a conference list screen displayed by the information recording app;

FIG. 21 is an example of a sequence diagram illustrating a process from the start of a conference to creation of a panoramic image by the meeting device;

FIG. 22 is a diagram illustrating an example of a height of the panoramic image determined in response to detection of faces of participants;

FIG. 23 is a diagram illustrating an example method of an operation of setting a direction of the electronic whiteboard through pressing of a position registration button;

FIG. 24 is a diagram illustrating an example of a screen for checking the direction set by the user;

FIGS. 25A and 25B are diagrams illustrating an example of a screen, displayed by the electronic whiteboard, for setting a method of detecting the direction of the electronic whiteboard;

FIG. 26 is a diagram illustrating an example of a two-dimensional code displayed as a specific image by the electronic whiteboard;

FIG. 27 is a diagram illustrating an example method of determining the direction of the electronic whiteboard based on a specific sound output by the electronic whiteboard;

FIG. 28 is a sequence diagram illustrating an example of a process in which the meeting device generates a panoramic image including the electronic whiteboard, based on the specific image or the specific sound;

FIG. 29 is a diagram illustrating an example of an automatic detection setting screen for the electronic whiteboard, displayed by the information recording app;

FIG. 30 is a diagram illustrating an example of the electronic whiteboard detected through image processing such as machine learning;

FIG. 31 is a diagram illustrating an example of a height of the panoramic image determined based on the electronic whiteboard detected through image processing;

FIG. 32 is a diagram illustrating an example method of generating a panoramic image from a spherical image;

FIG. 33 is a diagram illustrating an example of a combined image displayed by the information recording app;

FIG. 34 is an example of a flowchart for describing a process in which a first image generation unit determines the height of the panoramic image;

FIG. 35 is a diagram illustrating an example of the electronic whiteboard arranged at the center of the panoramic image;

FIGS. 36A, 36B, and 36C are diagrams each illustrating an example of the panoramic image generated when a display range fixing button is off;

FIGS. 37A, 37B, and 37C are diagrams each illustrating an example of the panoramic image generated when a display range fixing button is on;

FIG. 38 is an example of a flowchart for describing a process in which the first image generation unit generates the panoramic image when the display range fixing button is on or off;

FIGS. 39A, 39B, and 39C are diagrams each illustrating an example of the panoramic image from which a part of the panoramic image in the horizontal direction is cut off;

FIGS. 40A and 40B are diagrams illustrating an example of a process of omitting an excessive space when a space is present between participants in the panoramic image; and

FIG. 41 is an example of a sequence diagram illustrating a procedure in which the information recording app records a panoramic image, speaker images, and a screen of an app.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below. As used herein, the singular forms “a,” “an,” and “the” are intended to include the plural forms as well, unless the context clearly indicates otherwise.

An information processing system and a display method carried out by the information processing system will be described below as an example of embodiments of the present disclosure. The embodiments enable, when a plurality of targets is to be included in an image, the image appropriately displaying the plurality of targets to be generated.

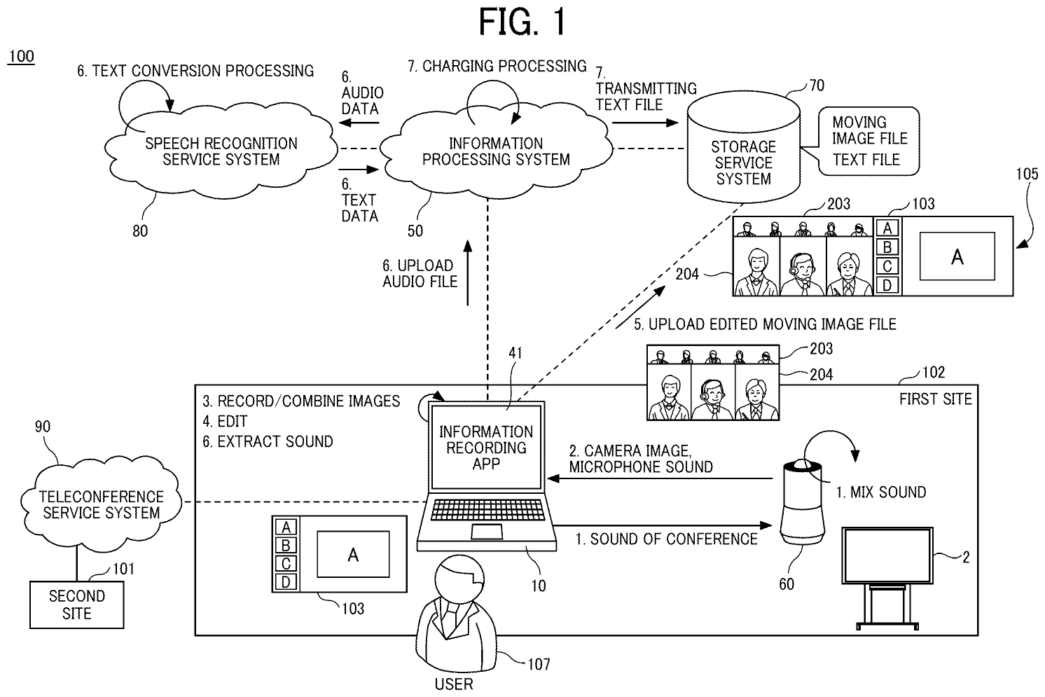

Example of Method of Creating Minutes of Teleconference An overview of a method of creating minutes using a panoramic image and a screen of an app will be described with reference to FIG. 1. FIG. 1 is a diagram illustrating an overview of creation of a record for storing a screen of an app executed during a teleconference, together with a panoramic image of surroundings. As illustrated in FIG. 1, a user 107 at a first site 102 uses a teleconference service system 90 to have a teleconference with a user at a second site 101.

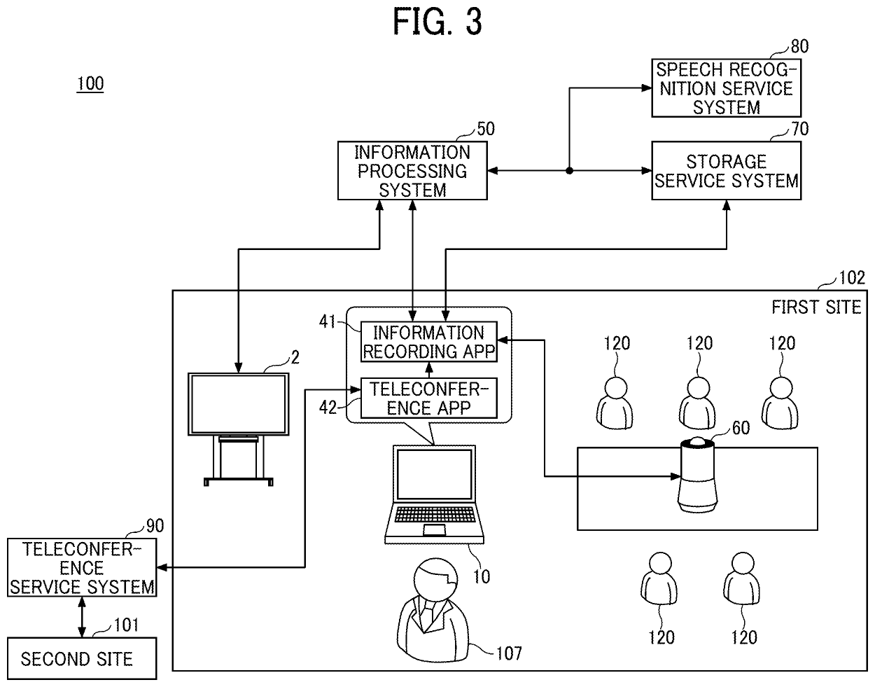

A record creation system 100 (information processing system) according to the present embodiment includes a meeting device 60 and a communication terminal 10. The meeting device 60 includes an image-capturing device that captures an image of a 360-degree surrounding space, a microphone, and a speaker. The meeting device 60 processes information of the captured image of the surrounding space to obtain a horizontal panoramic image (hereinafter, referred to as a panoramic image). The record creation system 100 uses the panoramic image and a screen created by an app executed by the communication terminal to create record such as minutes. The record creation system 100 combines audio data received by a teleconference app 42 (see FIG. 3) and audio data obtained by the meeting device 60 together and includes the resultant audio data in the record. The overview will be described below.
(1) An information recording app 41 (described later) and the teleconference app 42 (described later) are operating on the communication terminal 10. Another app such as a document display app may also be operating. The information recording app 41 transmits audio data output by the communication terminal 10 (including audio data received by the teleconference app 42 from the second site 101) to the meeting device 60. The meeting device 60 mixes (combines) audio data obtained by the meeting device 60 and the audio data received by the teleconference app 42 together.
(2) The meeting device 60 includes the microphone. Based on a direction from which the microphone obtains sound, the meeting device 60 performs processing of clipping speaker-including portions from a panoramic image to create speaker images. The meeting device 60 transmits both the panoramic image and the speaker images to the communication terminal 10.
(3) The information recording app 41 operating on the communication terminal 10 displays a panoramic image 203 and talker images 204. The information recording app 41 combines the panoramic image 203 and the talker images 204 with a screen of any app (for example, a screen 103 of the teleconference app 42) selected by the user 107. For example, the information recording app 41 combines the panoramic image 203 and the talker images 204 with the screen 103 of the teleconference app 42 to create a combined image 105 such that the panoramic image 203 and the talker image 204 are arranged on the left side and the screen 103 of the teleconference app 42 is arranged on the right side. The screen of the app is an example of screen information (described below) displayed by each application such as the teleconference app 42. Since the processing (3) is repeatedly performed, the resultant combined images 105 form a moving image (hereinafter, referred to as a combined moving image). The information recording app 41 attaches the combined audio data to the combined moving image to create a moving image with sound.

In the present embodiment, an example of combining the panoramic image 203, the talker images 204, and the screen 103 of the teleconference app 42 together is described. Alternatively, the panoramic image 203, the talker images 204, and the screen 103 of the teleconference app 42 may be stored separately and arranged on a screen at the time of playback by the information recording app 41.
(4) The information recording app 41 receives an editing operation (performed by the user 107 to cut off a portion not to be used), and completes the combined moving image. The combined moving image is a part of the record.
(5) The information recording app 41 transmits the created combined moving image (with sound) to a storage service system 70 for storage.
(6) The information recording app 41 extracts the audio data from the combined moving image (or may keep the original audio data to be attached) and transmits the extracted audio data to an information processing system 50. The information processing system 50 receives the audio data and transmits the audio data to a speech recognition service system 80 that converts the audio data into text data. The speech recognition service system 80 converts the audio data into text data. The text data includes data indicating a time, from the start of recording, when a speaker made an utterance.

In the case of real-time conversion into text data, the meeting device 60 transmits the audio data directly to the information processing system 50. The meeting device 60 then transmits the resultant text data to the information recording app 41 in real time.
(7) The information processing system 50 additionally stores the text data in the storage service system 70 storing the combined moving image. The text data is a part of the record.

The information processing system 50 performs a charging process for a user according to a service used by the user. For example, the charge is calculated based on an amount of the text data, a file size of the combined moving image, a processing time, or the like.

As described above, the combined moving image displays the panoramic image 203 of the surroundings including the user 107 and the talker images 204 as well as the screen of the app such as the teleconference app 42 displayed during the teleconference. When a participant or non-participant of the teleconference views the combined moving image as the minutes, the teleconference is reproduced with the realism.

Example of Generation of Panoramic Image

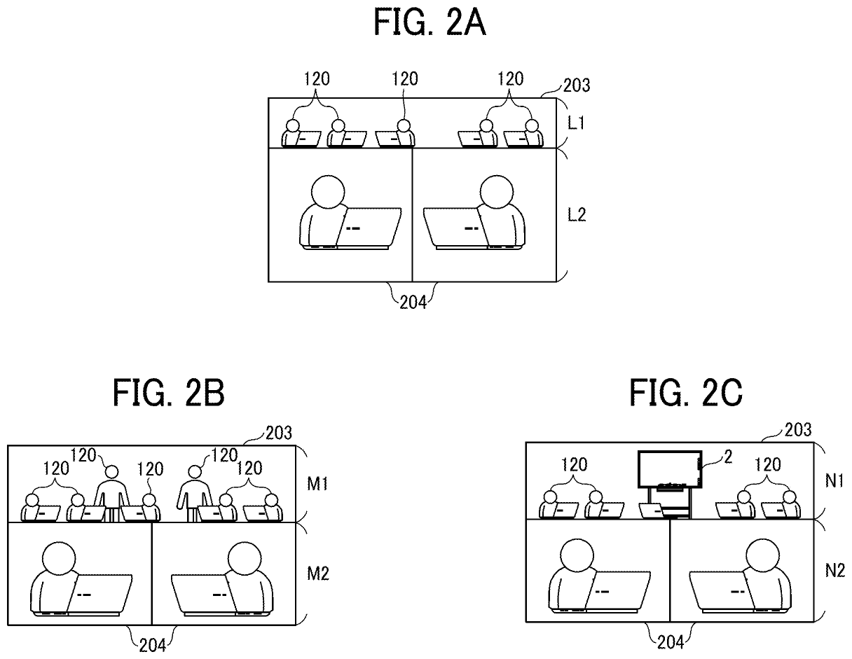

A method of generating a panoramic image according to the present embodiment will be described next with reference to FIGS. 2A to 2C. FIGS. 2A to 2C illustrate an example of the generated panoramic image 203. In FIGS. 2A to 2C, one panoramic image 203 (an example of a first image) and two talker images 204 (an example of a second image) are arranged and displayed in one screen. The number of talker images 204 is merely an example. No talker image 204 may be displayed, or three or more talker images 204 may be displayed.

FIG. 2A illustrates the panoramic image 203 in which a plurality of participants 120 is all seated. In this case, the panoramic image 203 has a height L1 and the talker images 204 have a height L2.

FIG. 2B illustrates the panoramic image 203 and the talker images 204 in the case where some of the plurality of participants 120 are standing. The meeting device 60 increases the height of the panoramic image 203 such that the panoramic image 203 includes faces of all the participants 120. For example, the meeting device 60 detects faces of the respective participants 120 and determines the height of the panoramic image 203 such that the panoramic image 203 at least includes the faces of all the participants 120. In FIG. 2B, the panoramic image 203 has a height M1 and the talker images 204 has a height M2. Thus, the heights L1, L2, M1, and M2 have the following relationships.

L1<M1,L2>M2

FIG. 2C illustrates the panoramic image 203 and the talker images 204 created such that the panoramic image 203 includes an electronic whiteboard 2. The meeting device 60 detects the electronic whiteboard 2 in accordance with some methods (described later), and increases the height of the panoramic image 203 such that the panoramic image 203 includes the faces of all the participants 120 and the electronic whiteboard 2. For example, the meeting device 60 detects the faces of the respective participants 120 and the electronic whiteboard 2, and determines the height of the panoramic image 203 such that the panoramic image 203 includes the faces of all the participants 120 and the electronic whiteboard 2. In FIG. 2C, the panoramic image 203 has a height N1, and the talker images 204 have a height N2. Thus, the heights L1, L2, N1, and N2 have the following relationships.

L1<N1,L2>N2

In the cases of FIGS. 2B and 2C, the meeting device 60 adjusts (reduces in this case) the height of the panoramic image 203 when all the participants 120 are seated or when the electronic whiteboard 2 is no longer detected.

As described above, the meeting device 60 according to the present embodiment detects a plurality of targets preset in a detection setting (such as a face of a participant and a device such as the electronic whiteboard 2), and determines the height of the panoramic image 203 such that the panoramic image 203 includes the targets. Thus, the meeting device 60 successfully displays the targets. If a plurality of targets to be included in an image is present, the meeting device 60 successfully displays appropriate targets.

### Terms

The term “application (app)” refers to software developed or used for a specific function or purpose. Types of such applications include a native app and a web app. A web app (a cloud app that provides a cloud service) may operate in cooperation with a native app or a web browser.

The expression “app being executed” refers to an app in a state from the start of the app to the end of the app. An app is not necessarily active (an app in the foreground) and may operate in the background.

An image of a surrounding space acquired by the meeting device is a spherical image. A panoramic image captured with an angle of view wider than a normal angle of view in the horizontal direction is generated from the spherical image. The term “spherical image” refers to a wide-angle image of a surrounding space over substantially 360 degrees in the vertical and horizontal directions. The spherical image does not have to be an image of 360 degrees and may be an image of substantially the entire range around the meeting device 60. The spherical image is sometimes referred to as an omnidirectional image or a 360-degree image.

The spherical image is not necessarily captured by the single meeting device 60, and may be captured by a combination of a plurality of image-capturing devices having an ordinary angle of view. A hemispherical image (an image having about 360-degree angle of view in the horizontal direction and about 90-degree angle of view in the vertical direction) may be used instead of the spherical image.

The term “panoramic image” refers to an image of a surrounding space over substantially 360 degrees in the horizontal direction acquired from the spherical image. The panoramic image does not have to be an image of 360 degrees and may be a wide-angle image of about 180 degrees.

The term “record” refers to information that is recorded by the information recording app 41. The record is stored/saved to be viewed as information associated with identification information of a certain conference (meeting, communication, or event). The record includes, for example, information as follows:
moving image information created based on information such as screen information displayed by a selected app (such as the teleconference app 42) and image information of the surroundings of a device obtained by the device;
combined audio information obtained by the teleconference app 42 (communication terminal) and the meeting device at a site during the conference (meeting);
text information converted from the obtained audio information; and
other data and images that are information related to the conference (meeting).
   The other data and images include, for example, a material file used during the conference, an added memo, translated data of the text data, images and stroke data created by a cloud electronic whiteboard service during the conference.

When the information recording app 41 records the screen of the teleconference app 42 and the conference at the site, the record may serve as the minutes of the held conference. The minutes are an example of the record. The way the record is called changes according to an activity performed in the teleconference or at the site, and the record may be called, for example, a record of a communication, a record of a scene (situation) at a site, or a record of an event. The record includes, for example, files of a plurality of formats such as a moving image file (such as a combined moving image), an audio file, a text data file (text data obtained through speech recognition on audio), a document file, an image file, and a spreadsheet file. The files are mutually associated with identification information of the conference. Thus, when the files are viewed, the files are collectively or selectively viewable in time series.

The term “tenant” refers to a group of users (such as a company, a local government, or an organization that is part of such a company or local government) that has a contract to receive a service from a service provider. In the present embodiment, creation of the record and conversion into text data are performed since the tenant has a contract with the service provider.

The term “telecommunication” refers to audio-and-video-based communication using software and communication terminals with a counterpart at a physically remote site.

A teleconference is an example of telecommunication. A conference may also be referred to as an assembly, a meeting, an arrangement, a consultation, an application for a contract or the like, a gathering, a meet, a meet-up, a seminar, a workshop, a study meeting, a study session, a training session, or the like.

The term “site” refers to a place where an activity is performed. A conference room is an example of the site. The conference room is a room set up to be used primarily for a conference. The term “site” may also refer to various places such as a home, a reception, a store, a warehouse, and an outdoor site, and may refer to any place or space where a communication terminal, a device, or the like is installable.

The term “sound” refers to an utterance made by a person, a surrounding sound, or the like. The term “audio data” refers to data to which the sound is converted. However, in the present embodiment, the sound and the audio data will be described without being strictly distinguished from each other.

A plurality of targets set in advance is targets desirably displayed in a panoramic image, and correspond to a participant's face (person's face) and the electronic whiteboard 2 in the present embodiment. The electronic whiteboard 2 may also be referred to as an electronic information board or the like. A projector is known as an equivalent device of the electronic whiteboard 2. The targets may also be electronic devices such as a digital signage, a television, a display, a multifunction peripheral, and a teleconference terminal. The user is allowed to set the targets desirably displayed in the panoramic image. In this case, the meeting device 60 or the communication terminal 10, which has learned the shape of the object in advance, detects the object selected by the user from the panoramic image. A plurality of kinds of targets may be present at the same time. For example, the meeting device 60 or the like may recognize a person's face and an electronic device as the targets at the same time.

An area of an image is defined by a height and a width of the image, and specified by the number of pixels, a length, or the like.

Example of System Configuration

An example of a system configuration of the record creation system 100 will be described with reference to FIG. 3. FIG. 3 illustrates an example of the configuration of the record creation system 100. FIG. 3 illustrates one site (the first site 102 on which the meeting device 60 is located) among a plurality of sites between which a teleconference is held. The communication terminal 10 at the first site 102 communicates with the information processing system 50, the storage service system 70, and the teleconference service system 90 via a network. The meeting device 60 and the electronic whiteboard 2 are disposed at the first site 102. The communication terminal 10 is communicably connected to the meeting device 60 via a Universal Serial Bus (USB) cable, a High-Definition Multimedia Interface (HDMI) cable, or the like. The communication terminal 10 may communicate with the meeting device 60 via a local area network (LAN). The meeting device 60 and the communication terminal 10 (or the information recording app 41) function as an information processing system.

At least the information recording app 41 and the teleconference app 42 operate on the communication terminal 10. The teleconference app 42 can communicate with the communication terminal 10 at the second site 101 via the teleconference service system 90 over the network to allow users at the sites to have a conference from the remote places. The information recording app 41 uses functions of the information processing system 50 and the meeting device 60 to create record in the teleconference held by the teleconference app 42.

In the present embodiment, an example of creating record during a teleconference will be described. However, the conference is not necessarily a conference that involves communication to a remote site. That is, the conference may be a conference in which participants at one site participate. In this case, sound collected by the meeting device 60 is stored without being combined. The rest of the process performed by the information recording app 41 is the same.

The communication terminal 10 includes a camera having an ordinary angle of view built therein (or may include a camera externally attached thereto). The camera captures an image of a front space including the user 107 who operates the communication terminal 10. The ordinary angle of view refers to a non-panoramic image. In the present embodiment, the ordinary angle of view refers to a flat image that is not a curved-surface image such as a spherical image. The communication terminal 10 includes a microphone built therein (or may include a microphone externally attached thereto). The microphone collects sound around the user 107 or the like who operates the communication terminal 10. Thus, the user 107 can have a common teleconference using the teleconference app 42 without being conscious of the information recording app 41. The information recording app 41 and the meeting device 60 do not affect the teleconference app 42 except for an increase in the processing load of the communication terminal 10.

The information recording app 41 is an app that communicates with the meeting device 60, and creates and records record. The meeting device 60 is a device for a meeting, including an image-capturing device that captures a panoramic image, a microphone, and a speaker. The camera included in the communication terminal 10 can capture an image of a limited range of the front space. In contrast, the meeting device 60 can capture an image of the entire space around the meeting device 60 (the space subjected to image-capturing is not necessarily the entire space). The meeting device 60 can keep a plurality of participants 120 illustrated in FIG. 3 within the angle of view at all times.

The meeting device 60 also clips a speaker image from a panoramic image and combines audio data obtained by the meeting device 60 and audio data output by the communication terminal 10 (including audio data received by the teleconference app 42). The place where the meeting device 60 is installed is not limited to on a desk or a table, and the meeting device 60 may be disposed at any place at the first site 102. Since the meeting device 60 can capture a spherical image, the meeting device 60 may be disposed on a ceiling, for example. The meeting device 60 may be installed at another site or at any site.

The information recording app 41 displays a list of apps executing on the communication terminal 10, combines images for the above-described record (creates the combined moving image), plays the combined moving image, receives editing, and the like. The information recording app 41 also displays a list of teleconferences that have been held or are to be held. The list of teleconferences is used in information related to record to allow the user to link a teleconference with the record.

The teleconference app 42 is an application that establishes a connection to and communicates with another communication terminal at the second site 101, transmits and receives an image and sound, displays the image and outputs the sound to allow the communication terminal 10 to perform telecommunication with the other communication terminal. The teleconference app 42 may be referred to as a telecommunication app, a remote information sharing app, or the like.

The information recording app 41 and the teleconference app 42 each may be a web app or a native app. A web app is an app in which a program on a web server and a program on a web browser or a native app cooperate with each other to perform processing, and is not to be installed on the communication terminal 10. A native app is an app that is installed and used on the communication terminal 10. In the present embodiment, both the information recording app 41 and the teleconference app 42 are described as native apps.

The communication terminal 10 may be a general-purpose information processing apparatus having a communication function, such as a personal computer (PC), a smartphone, or a tablet terminal, for example. The communication terminal 10 may also be the electronic whiteboard 2, a game machine, a personal digital assistant (PDA), a wearable PC, a car navigation system, an industrial machine, a medical device, a smart home appliance, or the like. The communication terminal 10 may be any apparatus on which at least the information recording app 41 and the teleconference app 42 operate. The communication terminal 10 may be any apparatus on which the information recording app 41 and the teleconference app 42 operate.

The electronic whiteboard 2 displays, on a display, data handwritten on a touch panel with an input means such as a pen or a finger. The electronic whiteboard 2 can communicate with the communication terminal 10 or the like in a wired or wireless manner, and capture a screen displayed by the communication terminal 10 and display the screen on the display. The electronic whiteboard 2 can convert handwritten data into text data, and share information displayed on the display with the electronic whiteboard 2 at another site. The electronic whiteboard 2 may be a whiteboard (blackboard or screen), not including a touch panel, onto which a projector projects an image. The electronic whiteboard 2 may be a tablet terminal, a notebook PC, a PDA, a game machine, or the like including a touch panel.

The electronic whiteboard 2 can communicate with the information processing system 50. For example, after being powered on, the electronic whiteboard 2 performs polling on the information processing system 50 to receive information from the information processing system 50.

The information processing system 50 includes one or more information processing apparatuses deployed over a network. The information processing system 50 includes one or more server apps that perform processing in cooperation with the information recording app 41, and an infrastructure service. The server apps manage a list of teleconferences, a record recorded during a teleconference, various settings and storage paths, and the like.

The infrastructure service performs user authentication, makes a contract, performs charging processing, and the like.

All or some of the functions of the information processing system 50 may exist in a cloud environment or in an on-premises environment. The information processing system 50 may include a plurality of server apparatuses or may include a single information processing apparatus. For example, the server apps and the infrastructure service may be provided by separate information processing apparatuses, and information processing apparatuses may exist for respective functions of the server apps. The information processing system 50 may be integrated with the storage service system 70 and the speech recognition service system 80 described below.

The storage service system 70 is a storage on a network, and provides a storage service for accepting storage of files and the like. Examples of the storage service system 70 include MICROSOFT ONEDRIVE, GOOGLE WORKSPACE, and DROPBOX. The storage service system 70 may be on-premises network-attached storage (NAS) or the like. The speech recognition service system 80 provides a service of performing speech recognition on audio data and converting the audio data into text data. The speech recognition service system 80 may be a general-purpose commercial service or part of the functions of the information processing system 50. As the speech recognition service system 80, different service systems may be set and used for different users or tenants or different conferences.

Example of Hardware Configuration

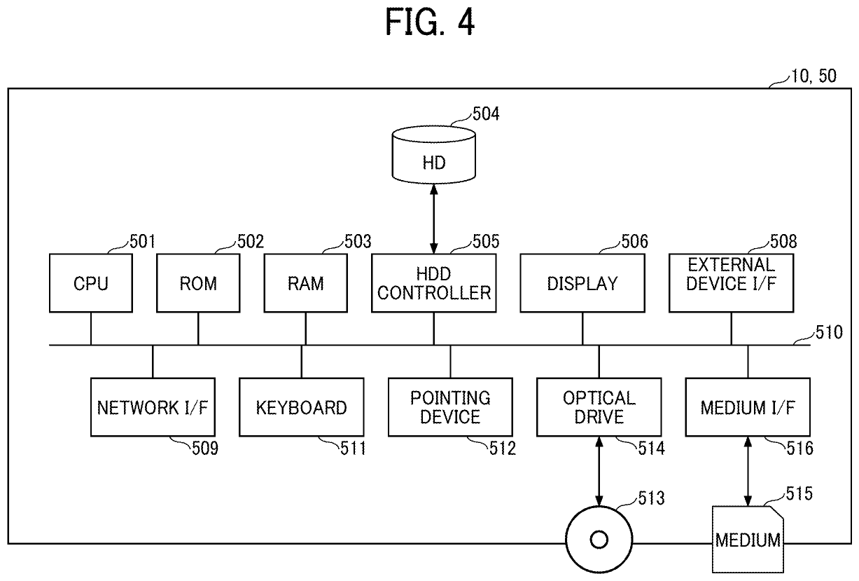

A hardware configuration of the information processing system 50 and the communication terminal 10 according to the present embodiment will be described with reference to FIG. 4.

Information Processing System and Communication Terminal

FIG. 4 illustrates an example hardware configuration of the information processing system 50 and the communication terminal 10 according to the present embodiment. As illustrated in FIG. 4, the information processing system 50 and the communication terminal are constructed by a computer and include a central processing unit (CPU) 501, a read-only memory (ROM) 502, a random access memory (RAM) 503, a hard disk (HD) 504, a hard disk drive (HDD) controller 505, a display 506, an external device interface (I/F) 508, a network I/F 509, a bus line 510, a keyboard 511, a pointing device 512, an optical drive 514, and a medium I/F 516.

The CPU 501 controls the overall operation of the information processing system 50 and the communication terminal 10. The ROM 502 stores a program used for driving the CPU 501 such as an initial program loader (IPL). The RAM 503 is used as a work area for the CPU 501. The HD 504 stores various data such as the program. The HDD controller 505 controls reading and writing of various data from and to the HD 504 under control of the CPU 501. The display 506 displays various information such as a cursor, menu, window, characters, or image. The external device I/F 508 is an interface for connecting various external devices. Examples of the external devices include, but not limited to, a USB memory and a printer. The network I/F 509 is an interface for performing data communication via a network. The bus line 510 is an address bus, a data bus, or the like for electrically connecting each component such as the CPU 501 illustrated in FIG. 4.

The keyboard 511 is an example of an input device provided with a plurality of keys used to input characters, numerals, or various instructions. The pointing device 512 is an example of an input device that allows a user to select or execute various instructions, select an item for processing, or move a cursor being displayed. The optical drive 514 controls reading or writing of various data from or to an optical recording medium 513, which is an example of a removable recording medium. The optical recording medium 513 may be a compact disc (CD), a digital versatile disc (DVD), a Blu-ray® disc, or the like. The medium I/F 516 controls reading and writing (storing) of data from and to a storage medium 515 such as a flash memory.

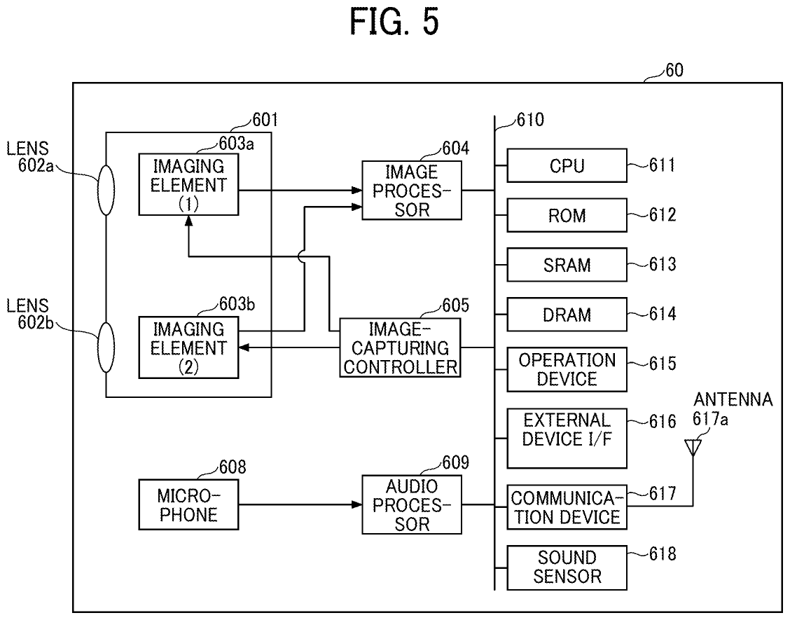

Meeting Device A hardware configuration of the meeting device 60 will be described with reference to FIG. 5. FIG. 5 is an example of a hardware configuration diagram of the meeting device 60 that captures a 360-degree moving image. In the description below, the meeting device 60 captures a moving image of a 360-degree space around the meeting device 60 at a predetermined height, with imaging elements, the number of which may be one or two or more. The meeting device 60 is not necessarily a dedicated device, and may be a PC, a digital camera, a smartphone, or the like to which an image-capturer for a 360-degree moving image is externally attached so that the PC, the digital camera, the smartphone, or the like has substantially the same functions as the meeting device 60.

As illustrated in FIG. 5, the meeting device 60 includes an image-capturer 601, an image processor 604, an image-capturing controller 605, a microphone 608, an audio processor 609, a CPU 611, a ROM 612, a static random access memory (SRAM) 613, a dynamic random access memory (DRAM) 614, an operation device 615, an external device I/F 616, a communication device 617, an antenna 617a, and a sound sensor 618. Examples of the external device I/F 616 include a USB terminal and a socket terminal for Micro-USB.

The image-capturer 601 includes wide-angle lenses (so-called fish-eye lenses) 602a and 602b having an angle of view of 360 degrees to form a hemispherical image, and imaging elements (image sensors) 603a and 603b provided for the wide-angle lenses 602a and 602b, respectively. Each of the imaging elements 603a and 603b includes an image sensor such as a complementary metal oxide semiconductor (CMOS) sensor or a charge coupled device (CCD) sensor, a timing generation circuit, and a group of registers. The image sensor converts an optical image formed by the corresponding wide-angle lens 602a or 602b into an electric signal to output image data. The timing generation circuit generates horizontal or vertical synchronization signals, pixel clocks, and the like for this image sensor. Various commands, parameters, and the like for operations of the corresponding imaging element are set in the group of registers. The image-capturer 601 may be a 360-degree camera and is an example of an image-capturing device that captures an image of a 360-degree space around the meeting device 60.

Each of the imaging elements 603a and 603b (image sensors) of the image-capturer 601 is connected to the image processor 604 via a parallel I/F bus. On the other hand, each of the imaging elements 603a and 603b of the image-capturer 601 is connected to the image-capturing controller 605 via a serial I/F bus (such as an I2C bus). The image processor 604, the image-capturing controller 605, and the audio processor 609, each of which may be implemented by a circuit, are each connected to the CPU 611 via a bus 610. The ROM 612, the SRAM 613, the DRAM 614, the operation device 615, the external device I/F 616, the communication device 617, the sound sensor 618, and the like are also connected to the bus 610.

The image processor 604 obtains image data output from each of the imaging elements 603a and 603b through the parallel I/F bus and performs predetermined processing on the image data to create data of a panoramic image and data of a speaker image from the fisheye video. The image processor 604 combines the panoramic image and the speaker image or the like together to output a single moving image.

The image-capturing controller 605 usually serves as a master device, whereas the imaging elements 603a and 603b usually serve as a slave device. The image-capturing controller 605 sets commands and the like in the groups of registers of the respective imaging elements 603a and 603b through the I2C bus. The image-capturing controller 605 receives the commands and the like from the CPU 611. The image-capturing controller 605 obtains status data and the like in the groups of registers of the respective imaging elements 603a and 603b through the I2C bus. The image-capturing controller 605 then sends the obtained status data and the like to the CPU 611.

The image-capturing controller 605 instructs the imaging elements 603a and 603b to output image data at a timing when an image-capturing start button of the operation device 615 is pressed or a timing when the image-capturing controller 605 receives an image-capturing start instruction from the CPU 611. The meeting device 60 sometimes has functions corresponding to a preview display function and a moving image display function implemented by a display (for example, a display of a PC or a smartphone). In case of displaying movie, the image data are continuously output from the imaging elements 603a and 603b at a predetermined frame rate (frames per minute).

Furthermore, the image-capturing controller 605 operates in cooperation with the CPU 611 to synchronize the time when the imaging element 603a outputs image data and the time when the imaging element 603b outputs the image data. In the present embodiment, the meeting device 60 does not include a display. However, in some embodiments, the meeting device 60 may include a display.

The microphone 608 converts sound into audio data (signals). The audio processor 609 obtains audio data output from the microphone 608 via an I/F bus and performs predetermined processing on the audio data.

The CPU 611 controls operations of the entire meeting device 60 and performs desirable processing. The ROM 612 stores various programs to be executed by the CPU 611.

Each of the SRAM 613 and the DRAM 614 is a work memory, and store programs being executed by the CPU 611 or data being processed. More specifically, in one example, the DRAM 614 stores image data currently processed by the image processor 604 and data of the equirectangular projection image on which processing has been performed.

The operation device 615 collectively refers to various operation buttons such as an image-capturing start button. The user operates the operation device 615 to start image-capturing or recording, power on or off the meeting device 60, establish a connection, perform communication, and input settings such as various image-capturing modes and image-capturing conditions.

The external device I/F 616 is an interface for connecting various external devices. Examples of the external devices in this case include, but not limited to, a PC, a display, a projector, and an electronic whiteboard. Examples of the external device I/F 616 may include a USB terminal and an HDMI terminal. The moving image data or image data stored in the DRAM 614 is transmitted to an external terminal or recorded in an external medium via the external device I/F 616. A plurality of external device I/Fs 616 may be used to, for example, while transmitting the image information obtained through image-capturing by the meeting device 60 to a PC via a USB to record the image information in the PC, acquire a video (for example, screen information to be displayed by the teleconference app) from the PC to the meeting device 60 and transmit the video from the meeting device 60 to another external device (such as a display, a projector, or an electronic whiteboard) via HDMI and display the video.

The communication device 617 may be implemented by a network interface circuit and communicate with a cloud server via the Internet by a wireless communication technology such as Wi-Fi via the antenna 617a provided in the meeting device 60, and transmit the stored moving image data or image data to the cloud server. The communication device 617 may communicate with a device located nearby by using a short-range wireless communication technology such as Bluetooth Low Energy (BLE®) or Near Field Communication (NFC).

The sound sensor 618 is a sensor that acquires 360-degree audio information in order to identify the direction from which a loud sound is input within a 360-degree space around the meeting device 60 (on a horizontal plane). The audio processor 609 determines the direction in which the volume of the sound is highest, based on the input 360-degree audio parameter, and outputs the direction from which the sound is input within the 360-degree space.

Note that another sensor (such as an azimuth/acceleration sensor or a Global Positioning System (GPS)) may calculate an azimuth, a position, an angle, an acceleration, or the like and use the calculated azimuth, position, angle, acceleration, or the like in image correction or position information addition.

The image processor 604 also performs processing described below.

The CPU 611 creates a panoramic image according to a method below. The CPU 611 performs predetermined camera image processing such as Bayer conversion (RGB interpolation processing) on raw data input from the image sensor that inputs a spherical video, and creates a fisheye image (a video including curved-surface images). The CPU 611 performs flattening processing such as dewarping processing (distortion correction processing) on the created fisheye video (curved-surface video) to create a panoramic image (video including flat-surface images) of a 360-degree space around the meeting device 60.

The CPU 611 creates a speaker image according to a method below. The CPU 611 clips a portion including a speaker from the panoramic image (video including flat-surface images) of the 360-degree surrounding space to create a speaker image. The CPU 611 assumes, as the direction of the speaker, the sound input direction identified from the 360-degree space output by using the sound sensor 618 and the audio processor 609, and clips the speaker image from the panoramic image.

At this time, in the method of clipping an image of a person based on the sound input direction, the CPU 611 clips a 30-degree portion around the sound input direction identified from the 360-degree space, and performs face detection on the 30-degree portion to clip the speaker image. The CPU 611 further identifies speaker images of a specific number of persons (three persons or the like) who have made an utterance most recently among the clipped speaker images.

The panoramic image and the one or more speaker images may be individually transmitted to the information recording app 41. Alternatively, the meeting device 60 may create one image from the panoramic image and the one or more speaker images and transmit the one image to the information recording app 41. In the present embodiment, the panoramic image and the one or more speaker images are individually transmitted from the meeting device 60 to the information recording app 41.

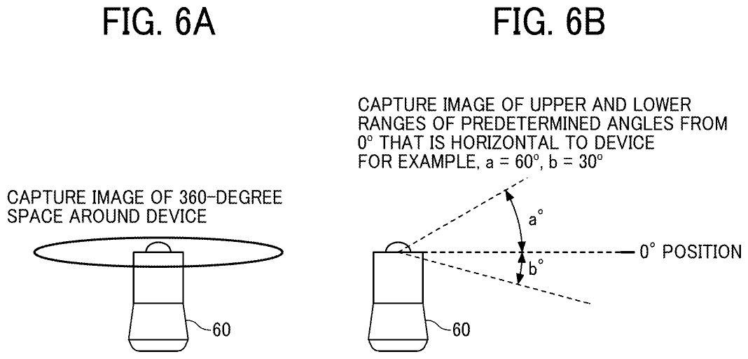

FIGS. 6A and 6B are diagrams illustrating an image-capturing range of the meeting device 60. As illustrated in FIG. 6A, the meeting device 60 captures an image of a 360-degree range in the horizontal direction. As illustrated in FIG. 6B, the meeting device 60 has an image-capturing range that extends upward and downward by predetermined angles (a degrees to b degrees) with respect to the direction horizontal to the height of the meeting device 60 which is defined as 0 degrees. In the present embodiment, the predetermined angles (a degrees to b degrees) are variable in the vertical direction.

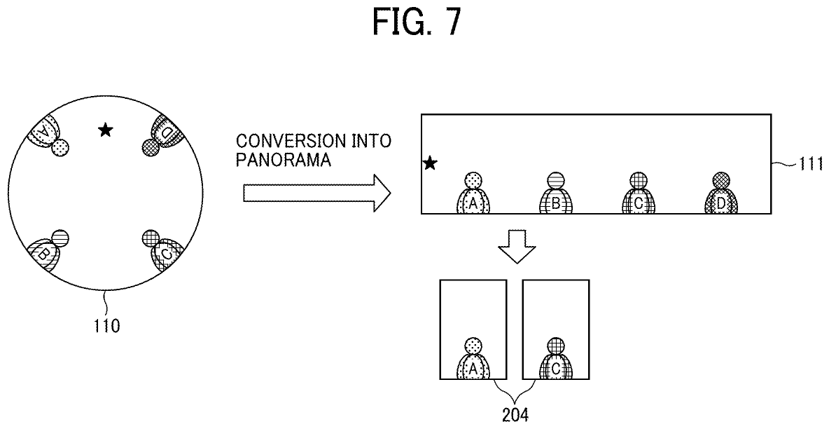

FIG. 7 is a diagram illustrating a panoramic image and clipping of speaker images. As illustrated in FIG. 7, an image captured by the meeting device 60 forms a portion 110 of a sphere, and thus has a three-dimensional shape. As illustrated in FIG. 6B, the meeting device 60 sections the angle of view into predetermined angles of the upward and downward ranges and predetermined angles of the leftward and rightward ranges, and performs perspective projection transformation on the resulting sections. The meeting device 60 thoroughly performs perspective projection transformation on the entire 360-degree range in the horizontal direction to obtain a predetermined number of flat images. The meeting device 60 laterally links the predetermined number of flat images together to obtain a panoramic image 111. The meeting device 60 performs face detection on a predetermined range around the sound direction in the panoramic image 111, and clips 15-degree leftward and rightward ranges from the center of the face (i.e., a 30-degree range in total) to create a talker image 204.

Electronic Whiteboard

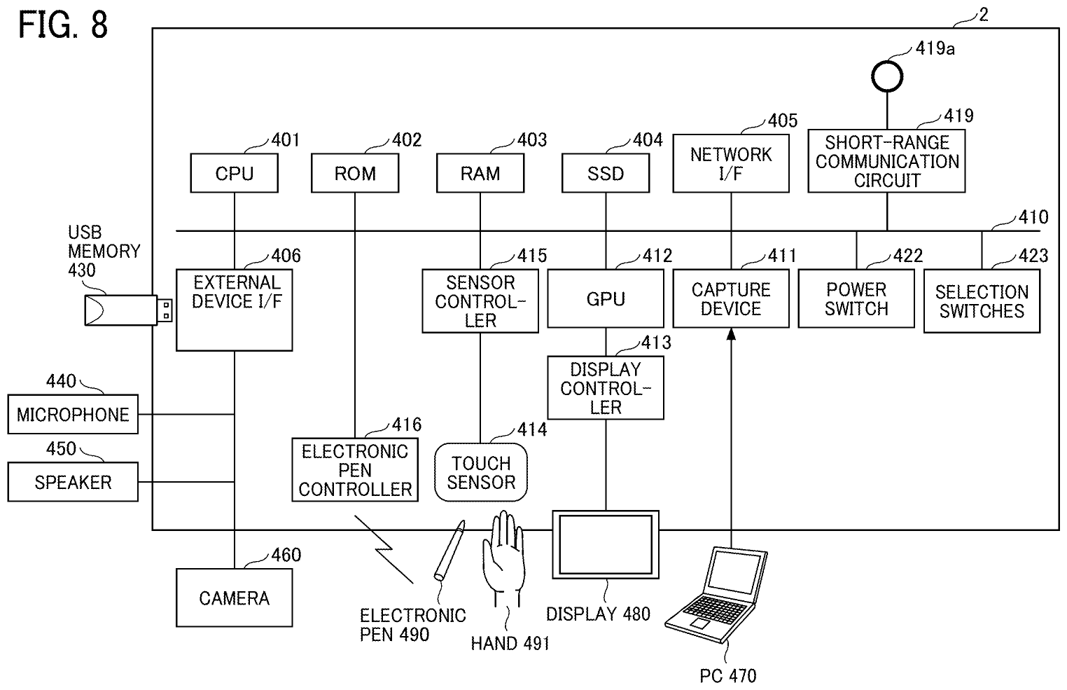

FIG. 8 is a diagram illustrating an example of a hardware configuration of the electronic whiteboard 2. As illustrated in FIG. 8, the electronic whiteboard 2 includes a CPU 401, a ROM 402, a RAM 403, a solid state drive (SSD) 404, a network I/F 405, and an external device I/F 406.

The CPU 401 controls overall operation of the electronic whiteboard 2. The ROM 402 stores a program such as an IPL to boot the CPU 401. The RAM 403 is used as a work area for the CPU 401.

The SSD 404 stores various kinds of data such as a program for the electronic whiteboard 2. The network I/F 405 controls communication with a communication network. The external device I/F 406 is an interface for connecting various external devices. Examples of the external devices in this case include, but not limited to, a USB memory 430 and externally-connected devices such as a microphone 440, a speaker 450, and a camera 460.

The electronic whiteboard 2 further includes a capture device 411, a graphics processing unit (GPU) 412, a display controller 413, a touch sensor 414, a sensor controller 415, an electronic pen controller 416, a short-range communication circuit 419, an antenna 419a of the short-range communication circuit 419, a power switch 422, and selection switches 423.

The capture device 411 causes a display of an external-connected PC 470 to display video information as a still image or a moving image. The GPU 412 is a semiconductor chip that exclusively handles graphics. The display controller 413 controls and manages displaying of a screen to display an image output from the GPU 412 on a display 480. The touch sensor 414 detects a touch of an electronic pen 490, a user's hand 491, or the like onto the display 480. The sensor controller 415 controls processing of the touch sensor 414. The touch sensor 414 receives a touch input and detects coordinates of the touch input according to the infrared blocking system. A method of receiving a touch input and detecting the coordinates of the touch input will be described. The display 480 is provided with two light emitting/receiving devices disposed on respective upper side ends of the display 480 and with a reflector member surrounding the display 480. The light emitting/receiving devices emit a plurality of infrared rays in parallel to a surface of the display 480. The plurality of infrared rays is reflected by the reflector member. The two light emitting/receiving devices receive light returning along the same optical path as the optical path of the emitted light.

The touch sensor 414 outputs identifiers (IDs) of infrared rays that are emitted from the two light emitting/receiving devices and are blocked by an object, to the sensor controller 415. Based on the IDs of the infrared rays, the sensor controller 415 detects coordinates of a position touched by the object. The electronic pen controller 416 communicates with the electronic pen 490 to detect a touch of the tip or bottom of the electronic pen 490 onto the display 480.

The short-range communication circuit 419 is a communication circuit that is compliant with NFC, Bluetooth®, or the like. The power switch 422 is used for powering on and off the electronic whiteboard 2. The selection switches 423 are a group of switches used for adjusting brightness, hue, etc. of images displayed on the display 480, for example.

The electronic whiteboard 2 further includes a bus line 410. Examples of the bus line 410 include, but are not limited to, an address bus and a data bus, which electrically connects the components such as the CPU 401 illustrated in FIG. 8 with each other.

Note that the touch sensor 414 is not limited to a touch sensor of the infrared blocking system, and may be a capacitive touch panel that detects a change in capacitance to identify the touched position. The touch sensor 414 may be a resistive-film touch panel that identifies the touched position based on a change in voltage across two opposing resistive films. The touch sensor 414 may be an electromagnetic inductive touch panel that detects electromagnetic induction generated by a touch of an object onto a display to identify the touched position. The touch sensor 414 may use any other various detection methods. The electronic pen controller 416 may determine whether there is a touch of another part of the electronic pen 490 such as a part of the electronic pen 490 held by the user as well as the tip and the bottom of the electronic pen 490.

Functions

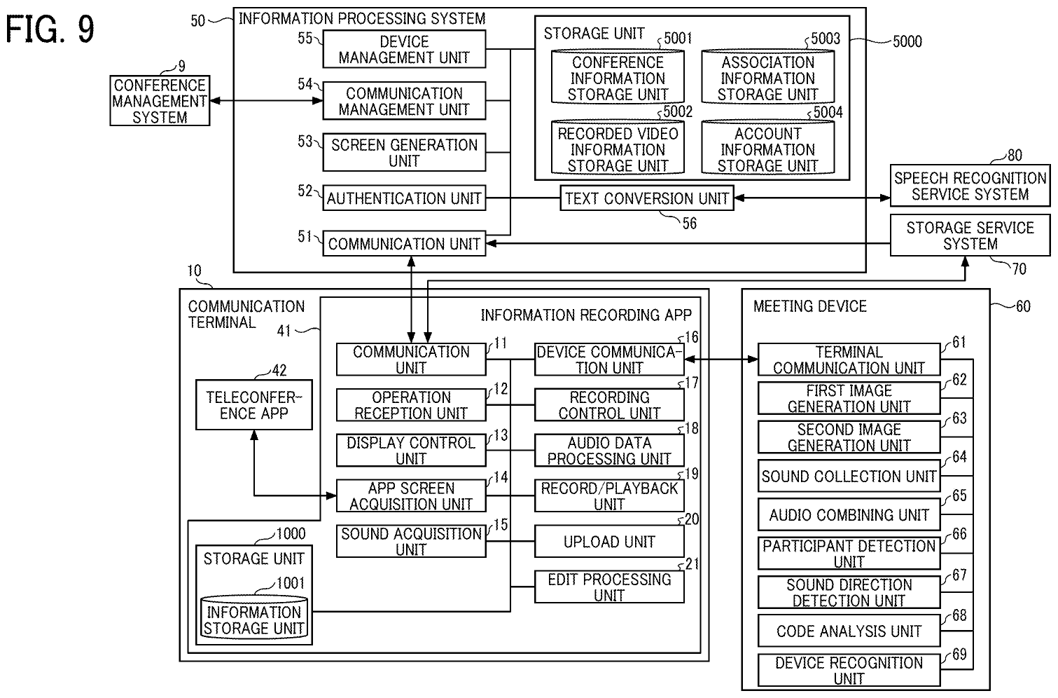

A functional configuration of the record creation system 100 will be described with reference to FIG. 9. FIG. 9 is an example of a functional block diagram illustrating, as individual blocks, functions of the communication terminal 10, the meeting device 60, and the information processing system 50 of the record creation system 100.

Communication Terminal

The information recording app 41 operating on the communication terminal 10 implements a communication unit 11, an operation reception unit 12, a display control unit 13, an app screen acquisition unit 14, a sound acquisition unit 15, a device communication unit 16, a recording control unit 17, an audio data processing unit 18, a record/playback unit 19, an upload unit 20, and an edit processing unit 21. These units of the communication terminal 10 are functions that are implemented by or means that are caused to function by one or more of the components illustrated in FIG. 4 obeying instructions of the CPU 501 according to the information recording app 41 loaded to the RAM 503 from the HD 504. The communication terminal 10 further includes a storage unit 1000, which is implemented by the HD 504 illustrated in FIG. 4. The storage unit 1000 includes an information storage unit 1001 implemented by a database, for example.

The communication unit 11 communicates various kinds of information with the information processing system 50 via a network.

For example, the communication unit 11 receives a list of teleconferences from the information processing system 50, and transmits an audio data recognition request to the information processing system 50.

The display control unit 13 displays various screens serving as a user interface in the information recording app 41, in accordance with screen transitions set in the information recording app 41. The operation reception unit 12 receives various operations performed on the information recording app 41.

The app screen acquisition unit 14 acquires screen information to be displayed by an app selected by a user, screen information of a desktop screen, or the like from an operating system (OS) or the like. When the app selected by the user is the teleconference app 42, the app screen acquisition unit 14 acquires a screen generated by the teleconference app 42 (an image including a captured image of a user of the communication terminal 10 captured by a camera of the communication terminal 10 at each site, a display image of a shared material, and participant icons, participant names, and the like). The screen information (app screen) displayed by the app is information that is displayed as a window by the app being executed and is acquired as an image by the information recording app 41. The window of the application is displayed on a monitor or the like such that the area of the window is rendered as an area in the entire desktop image. The screen information displayed by the app is acquirable by another app (such as the information recording app 41) as an image file or a moving image file including a plurality of consecutive images via an application programming interface (API) of the OS, an API of the app that displays the screen information, or the like. The screen information of the desktop screen is information including an image of the desktop screen generated by the OS, and is similarly acquirable as an image file or a moving image file via an API of the OS. The format of these image files may be bitmap, Portable Network Graphics (PNG), or any other format. The format of the moving image file may be MP4 or any other format.

The sound acquisition unit 15 acquires sound (including audio data received from the teleconference app 42 during the teleconference) output from a microphone or an earphone of the communication terminal 10. Even when the output sound is muted, the sound acquisition unit 15 can acquire the sound. A user operation such as selection of the teleconference app 42 is not to be performed for audio data, and the sound acquisition unit 15 can acquire sound to be output by the communication terminal 10 via an API of the OS or an API of the app. Thus, the audio data received by the teleconference app 42 from the second site 101 is also acquired. When the teleconference app 42 is not being executed or a teleconference is not being held, the information recording app 41 may fail to acquire the audio data. The sound acquired by the sound acquisition unit 15 may be the audio data to be output, without including the sound collected by the communication terminal 10. This is because the meeting device 60 separately collects the sound at the site.

The device communication unit 16 communicates with the meeting device 60 via a USB cable, an HDMI cable, or the like. The device communication unit 16 may communicate with the meeting device 60 via a wireless LAN, Bluetooth®, or the like. The device communication unit 16 receives the panoramic image 203 and the talker image 204 from the meeting device 60, and transmits the audio data acquired by the sound acquisition unit 15 to the meeting device 60. The device communication unit 16 receives the combined audio data obtained by the meeting device 60.

The recording control unit 17 combines the panoramic image 203 and the talker image 204 received by the device communication unit 16 and the screen of the app acquired by the app screen acquisition unit 14 together to create a combined image. The recording control unit 17 links the repeatedly created combined images in time series to create a combined moving image, and attaches the combined audio data to the combined moving image to create a combined moving image with sound. Note that the meeting device 60 may combine the panoramic image and the speaker image. A panoramic moving image including the panoramic images, a speaker moving image including the speaker images, an app screen moving image including the app screen, and a combined moving image including the panoramic images and the speaker images may be stored in the storage service system 70 as individual moving image files. In this case, the panoramic moving image, the speaker moving image, the app screen moving image, or the combined moving image of the panoramic images and the speaker images may be called and displayed on one display screen when being viewed.

The audio data processing unit 18 extracts audio data combined with the combined moving image, or requests the information processing system 50 to convert the combined audio data received from the meeting device 60 into text data.

The record/playback unit 19 plays the combined moving image. The combined moving image is stored in the communication terminal 10 during recording, and then uploaded to the information processing system 50.

After the teleconference ends, the upload unit 20 transmits the combined moving image to the information processing system 50.

The edit processing unit 21 edits (partially deletes, links, or the like) the combined moving image in accordance with a user operation.

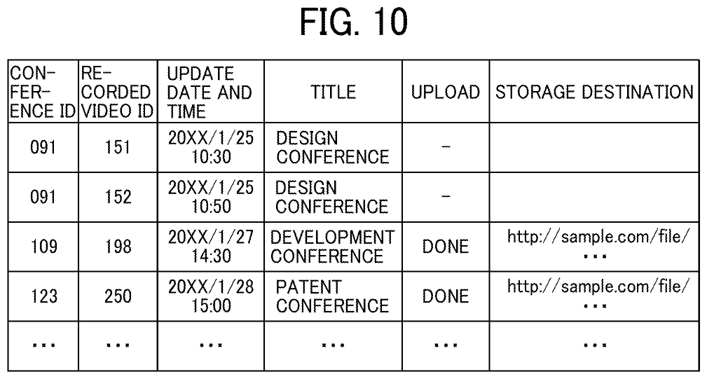

FIG. 10 illustrates example items of information on the recorded video, stored in the information storage unit 1001. The information on the recorded video includes items such as “conference ID,” “recorded video ID,” “update date and time,” “title,” “upload,” and “storage destination.” When a user logs into the information processing system 50, the information recording app 41 downloads conference information from a conference information storage unit 5001 of the information processing system 50. The conference ID or the like included in the conference information is reflected in the information on the recorded video. The information on the recorded video in FIG. 10 is held by the communication terminal 10 operated by a certain user.

The item “conference ID” is identification information for identifying a held teleconference. The conference ID is assigned when a schedule of the teleconference is registered to a conference management system 9, or is assigned by the information processing system 50 in response to a request from the information recording app 41. The conference management system 9 is a system to which a schedule of a conference or a teleconference, a Uniform Resource Locator (URL) (conference link) for starting the teleconference, reservation information of a device to be used in the conference, and the like are registered, and is a scheduler or the like connected from the communication terminal 10 via a network. The conference management system 9 can transmit the registered schedule or the like to the information processing system 50.

The item “recorded video ID” is identification information for identifying a combined moving image recorded during the teleconference.

The recorded video ID is assigned by the meeting device 60, but may be assigned by the information recording app 41 or the information processing system 50. Different recorded video IDs are assigned for the same conference ID when the recording is ended in the middle of the teleconference but is started again for some reason.

The item “update date and time” is a date and time when the combined moving image is updated (recording is ended). When the combined moving image is edited, the update date and time is the date and time of editing.

The item “title” is a name of the conference. The title may be set when the conference is registered to the conference management system 9, or may be set by the user in any manner.

The item “upload” indicates whether the combined moving image has been uploaded to the information processing system 50.

The item “storage destination” indicates a location (URL or file path) where the combined moving image and the text data are stored in the storage service system 70. The item “storage destination” allows the user to view the uploaded combined moving image as desired. Note that the combined moving image and the text data are stored with different file names following the URL, for example.

Meeting Device

Description with reference to FIG. 9 is continued. The meeting device 60 includes a terminal communication unit 61, a first image generation unit 62, a second image generation unit 63, a sound collection unit 64, an audio combining unit 65, a participant detection unit 66, a sound direction detection unit 67, a code analysis unit 68, and a device recognition unit 69. These units of the meeting device 60 are functions that are implemented by or means that are caused to function by one or more of the components illustrated in FIG. 5 obeying instructions of the CPU 611 according to the program loaded to the DRAM 614 from the ROM 612.

The terminal communication unit 61 communicates with the communication terminal via a USB cable, an HDMI cable, or the like. The terminal communication unit 61 may be connected to the communication terminal 10 by a cable. In some embodiments, the terminal communication unit 61 may be communicate with the communication terminal 10 via a wireless LAN, Bluetooth®, or the like.

The first image generation unit 62 generates the panoramic image 203. The second image generation unit 63 generates the talker image 204. The method of generating a panoramic image and a speaker image has been described with reference to FIGS. 6A to 7. The detailed description of this operation is described below. The information recording app 41 may include the first image generation unit 62 and/or the second image generation unit 63.

The sound collection unit 64 converts an audio signal acquired by the microphone 608 included in the meeting device 60 into (digital) audio data. Thus, the content of utterances made by the user and the participant at the site where the communication terminal is installed is collected.

The audio combining unit 65 combines the audio transmitted from the communication terminal 10 and the audio collected by the sound collection unit 64. Thus, the audio of utterances made at the second site 101 and the audio of utterances made at the first site 102 are combined together.

The participant detection unit 66 detects a participant from a spherical image. For example, the participant detection unit 66 performs face recognition with a machine learning technique such as deep learning or a support vector to detect a participant. The participant detection unit 66 detects a person's face. In another example, the participant detection unit 66 may detect a person's body as well as the person's face.

The sound direction detection unit 67 detects a sound of a specific frequency to detect the direction of the electronic whiteboard 2 in the panoramic image.

The code analysis unit 68 detects a two-dimensional code or barcode included in a panoramic image and analyzes the two-dimensional code or barcode to acquire information such as device identification information of the electronic whiteboard 2 included in the two-dimensional code or barcode. The communication terminal 10 may analyze the code.

The device recognition unit 69 learns the shape (circumscribed rectangle) of the electronic whiteboard 2 through machine learning in advance to detect the electronic whiteboard 2 from the panoramic image. The device recognition unit 69 may simply recognize the electronic whiteboard 2 through pattern matching without using machine learning. The communication terminal 10 may perform this device recognition.

Information Processing System

The information processing system 50 includes a communication unit 51, an authentication unit 52, a screen generation unit 53, a communication management unit 54, a device management unit 55, and a text conversion unit 56. These units of the information processing system 50 are functions that are implemented by or means caused to function by one or more of the hardware components illustrated in FIG. 4 obeying instructions from the CPU 501 according to the program loaded from the HD 504 to the RAM 503. The information processing system 50 also includes a storage unit 5000 (a memory) implemented by the HD 504 or the like illustrated in FIG. 4. The storage unit 5000 includes the conference information storage unit 5001, a recorded video information storage unit 5002, an association information storage unit 5003, and an account information storage unit 5004 each of which is implemented by a database, for example.

The communication unit 51 transmits and receives various kinds of information to and from the communication terminal 10. For example, the communication unit 51 transmits a list of teleconferences to the communication terminal 10, and receives an audio data recognition request from the communication terminal 10.

The authentication unit 52 authenticates a user who operates the communication terminal 10. For example, the authentication unit 52 authenticates a user based on whether authentication information (a user ID and a password) included in an authentication request received by the communication unit 51 matches authentication information held in advance. The authentication information may be a card number of an integrated circuit (IC) card, biometric information of a face, a fingerprint, or the like. The authentication unit 52 may use an external authentication system or an authentication method such as Open Authorization (OAuth) to perform authentication.

The screen generation unit 53 generates screen information to be displayed by the communication terminal 10. When the communication terminal 10 executes a native app, the communication terminal 10 holds the screen information and transmits the information to be displayed in a form of Extensible Markup Language (XML) or the like. When the communication terminal 10 executes a web app, the screen information is created by Hypertext Markup Language (HTML), XML, Cascade Style Sheet (CS S), JavaScript®, or the like.

The communication management unit 54 acquires information related to a teleconference from the conference management system 9 by using an account of each user or a system account assigned to the information processing system 50. The communication management unit 54 stores conference information of a scheduled conference in association with a conference ID in the conference information storage unit 5001. The communication management unit 54 acquires conference information for which a user belonging to the tenant has a right to view. Since the conference ID is set for a conference, the teleconference and the record are associated with each other by the conference ID.

The device management unit 55 associates the device identification information of the electronic whiteboard 2 and the device identification information of the meeting device 60 with the conference ID. That is, the device management unit 55 associates devices that participate in the same conference. In one method, the meeting device 60 acquires the device identification information displayed or output as sound by the electronic whiteboard 2, and the communication terminal 10 transmits the device identification information to the information processing system 50.

The text conversion unit 56 uses an external speech recognition service to convert audio data requested to be converted into text data by the communication terminal 10, into text data. In some embodiments, the text conversion unit 56 may perform this conversion.

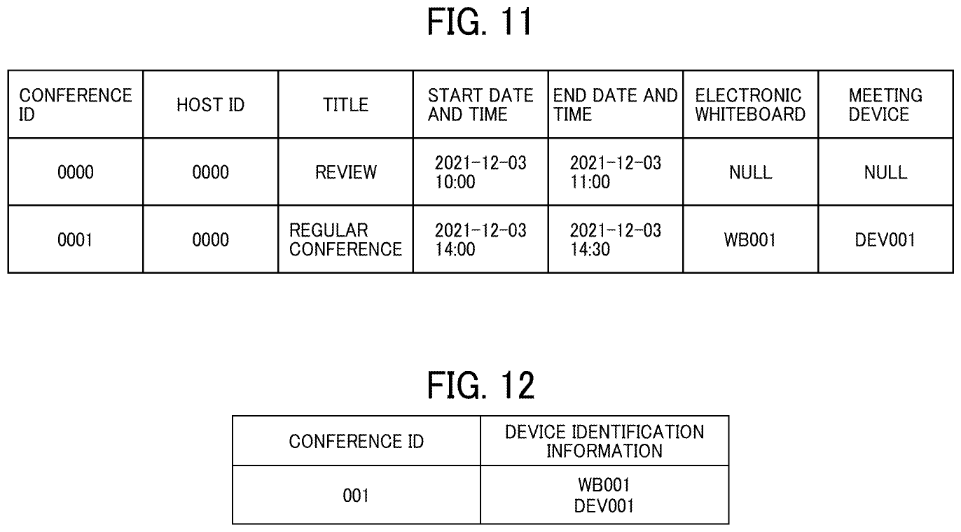

FIG. 11 illustrates an example of conference information stored in the conference information storage unit 5001 and managed by the communication management unit 54. The communication management unit 54 uses the aforementioned account to acquire a list of teleconferences for which a user belonging to a tenant has a right to view. The right to view may be directly given from the information recording app 41 of the communication terminal for conference information managed by the communication management unit 54. The list of teleconferences for which the user belonging to the tenant has the right to view includes conference information created by the user and conference information for which the user is given the right to view by another user. In the present embodiment, teleconferences are used as an example. However, the list of teleconferences also includes a conference held in a single conference room.

The conference information is managed based on the conference ID, which is associated with items “host ID,” “title” (conference name), “start date and time,” “end date and time,” “electronic whiteboard,” and “meeting device,” for example. These items are an example of the conference information, and the conference information may include other information.

The item “host ID” indicates a host of (a person who holds) the conference.

The item “title” indicates the details of the conference such as a name of the conference or a subject of the conference.

The item “start date and time” indicates a date and time at which the conference is scheduled to be started.

The item “end date and time” indicates a date and time at which the conference is scheduled to end.

The item “electronic whiteboard” indicates identification information of the electronic whiteboard 2 associated with the conference.

The item “meeting device” indicates identification information of the meeting device 60 used in the conference.

As illustrated in FIGS. 10 and 11, a combined moving image recorded at a conference is identified by the conference ID.

The information on the recorded video stored in the recorded video information storage unit 5002 may be the same as the information illustrated in FIG. 10. However, the information processing system 50 has a list of combined moving images recorded by all users belonging to the tenant. The user may input desired storage destination information in a user setting screen or the like of the information recording app 41 of the communication terminal 10, so that the storage destination (path information such as a URL of a cloud storage system) may be stored in the recorded video information storage unit 5002.

FIG. 12 illustrates association information stored in the association information storage unit 5003. The association information associates the conference ID and the device identification information (of the electronic whiteboard 2 and the meeting device 60) with each other. The association information is held from when the information recording app 41 transmits the device identification information to the information processing system 50 to when the recording ends.

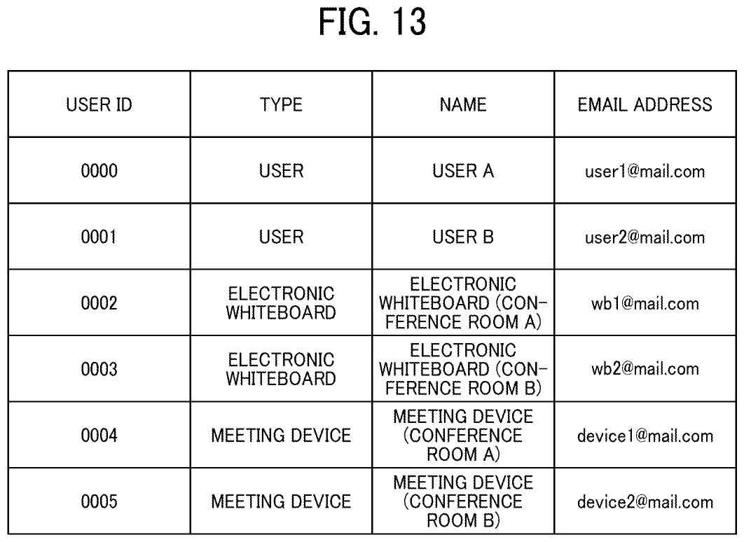

FIG. 13 illustrates an example of the account information stored in the account information storage unit 5004. The account information holds information for not only persons but also for the electronic whiteboard 2 and the meeting device 60 that are users other than persons.

The item “user ID” is identification information of a user, the electronic whiteboard 2, the meeting device 60, and the like that may participate in a conference.

The item “type” is a type of each account, i.e., the user, the electronic whiteboard 2, or the meeting device 60.

The item “name” is a name of the user or a name of the electronic whiteboard 2 or the meeting device 60.

The item “email address” is an email address of the user, the electronic whiteboard 2, the meeting device 60, or the like.

Electronic Whiteboard

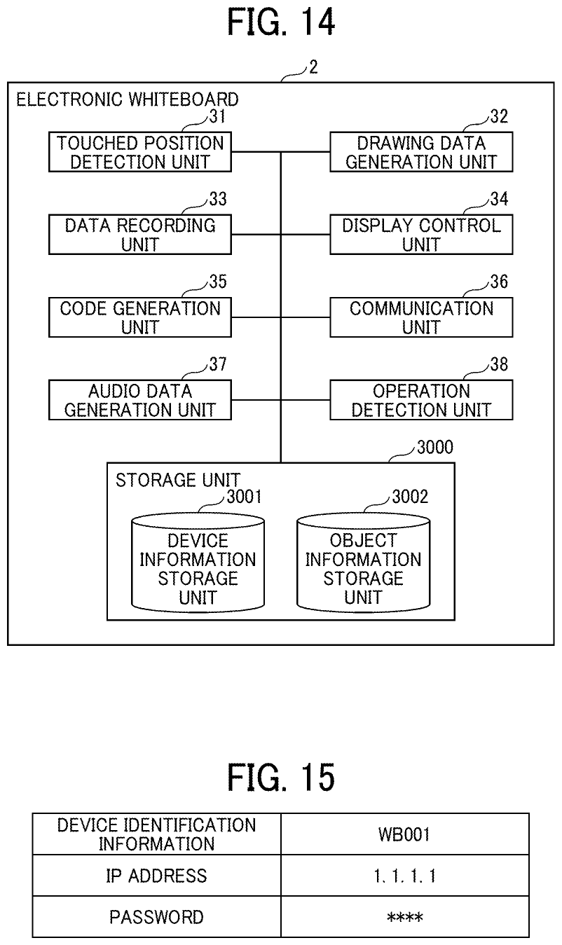

FIG. 14 is an example of a functional block diagram illustrating, as individual blocks, functions of the electronic whiteboard 2. The electronic whiteboard 2 includes a touched position detection unit 31, a drawing data generation unit 32, a data recording unit 33, a display control unit 34, a code generation unit 35, a communication unit 36, an audio data generation unit 37, and an operation detection unit 38. The respective functions of the electronic whiteboard 2 are functions or means that are implemented by one or more of the components illustrated in FIG. 8 obeying instructions from the SSD 404 according to a program loaded to the RAM 403 from the CPU 401.

The touched position detection unit 31 detects coordinates of a position where the electronic pen 490 has touched the touch sensor 414. The drawing data generation unit 32 acquires the coordinates of the position touched by the tip of the electronic pen 490 from the touched position detection unit 31. The drawing data generation unit 32 interpolates a sequence of coordinate points and links the resulting coordinate points to generate stroke data.

The display control unit 34 displays handwritten data, a character string converted from the handwritten data, a menu to be operated by the user, and the like on the display.

The data recording unit 33 stores, in an object information storage unit 3002, handwritten data handwritten on the electronic whiteboard 2, a figure such as a circle or triangle into which the handwritten data is converted, a stamp of “DONE” or the like, a PC screen, a file, or the like. Each of the handwritten data, the character string (including graphic), the image such as a PC screen, the file, and the like is treated as an object. Regarding handwritten data, a set of stroke data is one object grouped by time, for example, due to interruption of input of handwriting or by the position where the handwriting is input.

The communication unit 36 is connected to Wi-Fi or a LAN and communicates with the information processing system 50. The communication unit 36 transmits object information to the information processing system 50, receives object information stored in the information processing system 50 from the information processing system 50, and displays an object based on the object information on the display 480. The communication unit 36 communicates with the communication terminal 10 directly. In another example, the communication unit 36 communicates with the communication terminal 10 via the information processing system 50.

The code generation unit 35 encodes the device identification information of the electronic whiteboard 2 stored in a device information storage unit 3001 and information indicating that the electronic whiteboard 2 is a device usable in the conference into a two-dimensional pattern to generate a two-dimensional code. The code generation unit 35 may encode the device identification information of the electronic whiteboard 2 and the information indicating that the electronic whiteboard 2 is a device usable in the conference into a barcode. The device identification information may be a serial number, a Universally Unique Identifier (UUID), or the like. The device identification information may be set by the user.

The audio data generation unit 37 generates audio data according to a method of sampling a signal of a preset frequency (frequency indicating that the signal is output by the electronic whiteboard 2) at a certain interval as in pulse code modulation (PCM) conversion. The audio data is converted into an analog signal by a digital-to-analog (D/A) converter included in the speaker 450, and the analog signal is output from the speaker 450.

The operation detection unit 38 detects a user operation on the electronic whiteboard 2. For example, the operation detection unit 38 detects the start of an operation or the end of the operation in accordance with detection of a touch (or approach) of the electronic pen 490, the hand 491 of the user, or the like onto (to) the display 480 (touch panel) by the touched position detection unit 31.

The electronic whiteboard 2 also includes a storage unit 3000 implemented by the SSD 404 or the like illustrated in FIG. 8. The storage unit 3000 includes the device information storage unit 3001 and the object information storage unit 3002 each of which is implemented by a database.

FIG. 15 illustrates information such as device identification information stored in the device information storage unit 3001.

Device identification information is identification information of the electronic whiteboard 2.

An Internet Protocol (IP) address is used by another apparatus to connect to the electronic whiteboard 2 via a network.

A password is used for authentication performed when another apparatus connects to the electronic whiteboard 2.

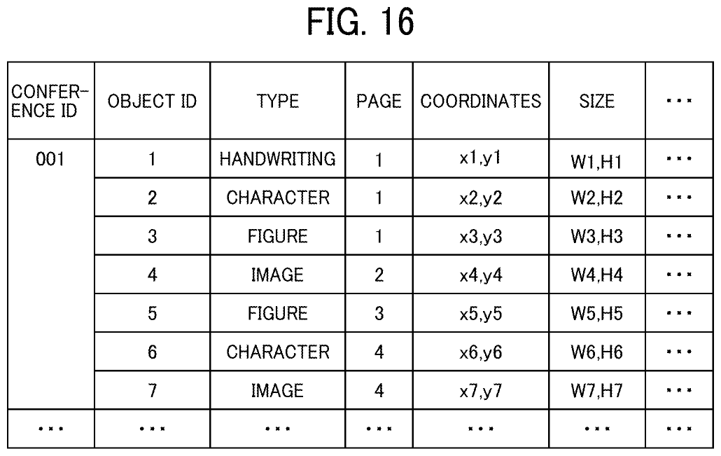

FIG. 16 is a diagram illustrating object information stored in the object information storage unit 3002. The object information is information for managing an object displayed by the electronic whiteboard 2. The object information is transmitted to the information processing system 50 and is used as minutes.

The item “conference ID” indicates identification information of a conference notified from the information processing system 50.

The item “object ID” indicates identification information for identifying an object.

The item “type” indicates a type of the object. Examples of the type include handwriting, character, figure, and image. The type “handwriting” indicates stroke data (sequence of coordinate points). The type “character” indicates a character string (character code) converted from handwritten data. The character string may also be referred to as text data. The type “figure” indicates a geometric shape converted from handwritten data, such as a triangle or a square. The type “image” indicates image data of Joint Photographic Experts Group (JPEG), PNG, or Tag Image File Format (TIFF) captured from a PC, the Internet, or the like.

A single screen of the electronic whiteboard 2 is referred to as a page. The item “page” indicates the page number.

The item “coordinates” indicate a position of an object relative to a predetermined origin of the electronic whiteboard 2. The position of the object is, for example, the upper left apex of the circumscribed rectangle of the object. The coordinates are expressed, for example, in units of pixels of the display.

The item “size” represents a width and a height of the circumscribed rectangle of the object.

Screen Transition

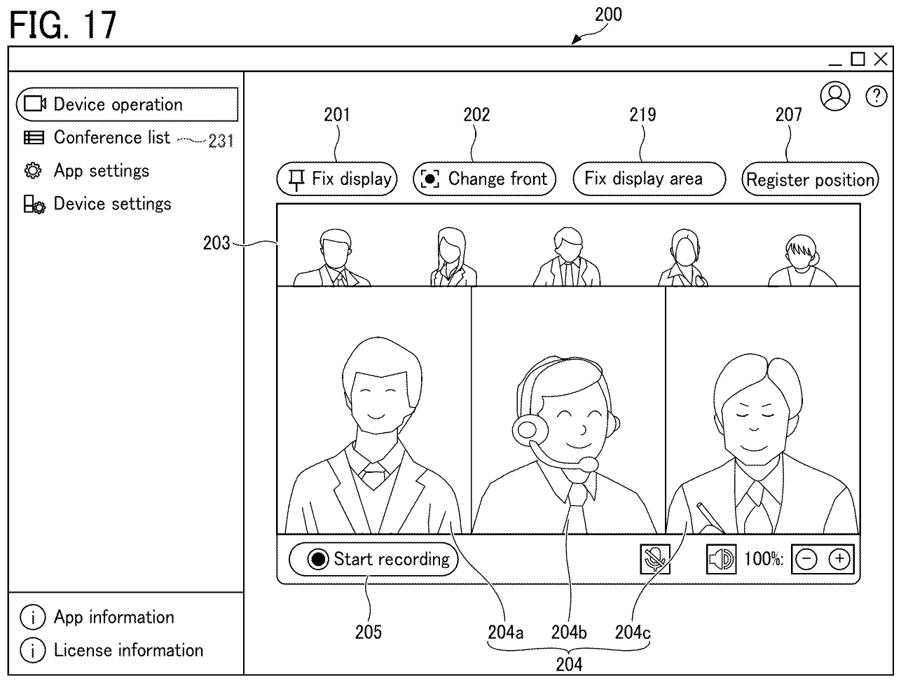

Several screens displayed by the communication terminal 10 during a teleconference will be described with reference to FIGS. 17 to 20. FIG. 17 illustrates an initial screen 200 displayed by the information recording app 41 operating on the communication terminal 10 after login. The user of the communication terminal 10 connects the information recording app 41 to the information processing system 50. The user inputs authentication information, and if the login is successful, the initial screen 200 of FIG. 17 is displayed.

The initial screen 200 includes a fixed display button 201, a front change button 202, a display range fixing button 219, a position registration button 207, the panoramic image 203, one or more talker images 204a to 204c (hereinafter referred to as talker images 204 when the talker images 204a to 204c are not distinguished from one another), and a recording start button 205. If the meeting device 60 has already been started and is capturing an image of the surroundings at the time of the login, the panoramic image 203 and the talker images 204 created by the meeting device 60 are displayed in the initial screen 200. This thus allows the user to decide whether to start recording while viewing the panoramic image 203 and the talker images 204. If the meeting device 60 is not started (is not capturing any image), the panoramic image 203 and the talker images 204 are not displayed.

The information recording app 41 may display the talker images 204 of all participants based on all faces detected from the panoramic image 203, or may display the talker images 204 of N persons who have made an utterance most recently. FIG. 17 illustrates an example in which the talker images 204 of up to three persons are displayed. Display of the talker image 204 of a participant may be omitted until the participant makes an utterance (in this case, the number of the talker images 204 increases by one in response to an utterance), or the talker images 204 of three participants in a predetermined direction may be displayed (the talker images 204 are switched in response to an utterance).

When no participants have made an utterance such as immediately after the meeting device 60 is started, an image of a predetermined direction (such as 0 degrees, 120 degrees, or 240 degrees) of 360 degrees in the horizontal direction is created as the talker image 204. When fixed display (described later) is set, the setting of the fixed display is prioritized.

The fixed display button 201 is a button with which the user performs an operation of fix a certain region of the panoramic image 203 as the talker image 204 in close-up.

The front change button 202 is a button with which the user performs an operation of changing the front of the panoramic image 203 (since the panoramic image includes the 360-degree space in the horizontal direction, the direction indicated by the right end matches the direction indicated by the left end). The user slides the panoramic image 203 leftward or rightward with a pointing device to determine a participant who is displayed in front. The user's operation is transmitted to the meeting device 60. The meeting device 60 changes the angle set as the front among 360 degrees in the horizontal direction, creates the panoramic image 203, and transmits the panoramic image 203 to the communication terminal 10.

The display range fixing button 219 is a button with which the user sets whether to reduce the size of the panoramic image 203 such that the panoramic image 203 fits in the display range of the information recording app 41 after the height of the panoramic image 203 is changed.

The position registration button 207 is a button with which the user performs an operation of setting a position (direction) of a device such as the electronic whiteboard 2.

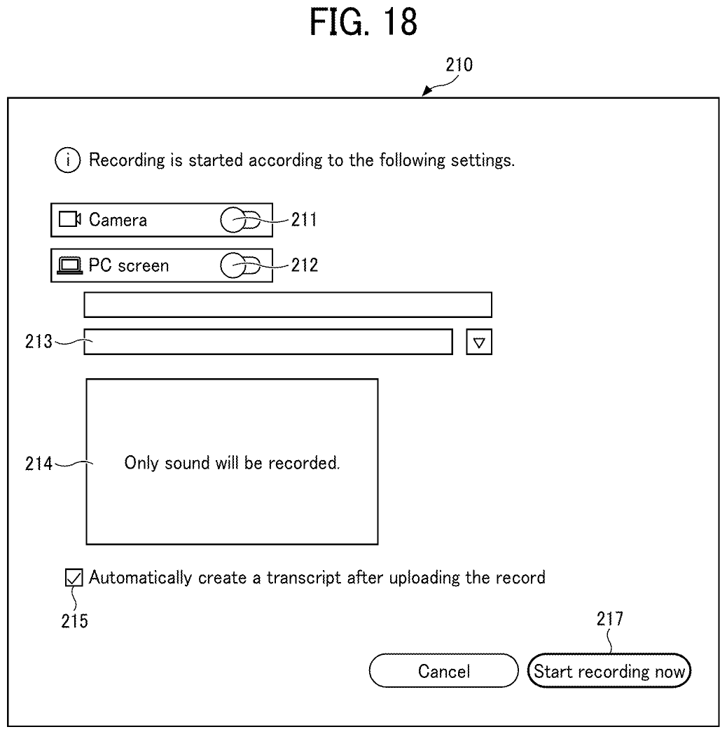

In response to the user pressing the recording start button 205, the information recording app 41 displays a recording setting screen 210 of FIG. 18.

FIG. 18 is an example of the recording setting screen 210 displayed by the information recording app 41. The recording setting screen 210 allows the user to set whether to record the panoramic image 203 and the talker images 204 created by the meeting device 60 and a desktop screen of the communication terminal 10 or a screen of an app operating on the communication terminal 10 (whether to include the images and screen in a recorded video). If the setting is made to record none of the panoramic image, the speaker images, and the desktop screen or the screen of the operating app, the information recording app 41 records sound (sound output by the communication terminal 10 and sound collected by the meeting device 60).

A camera toggle button 211 is a button for switching on and off recording of the panoramic image 203 and the talker images 204 created by the meeting device 60. The camera toggle button 211 may allow settings for recording a panoramic image and a speaker image to be made separately.

A PC screen toggle button 212 is a button for switching on and off recording of the desktop screen of the communication terminal 10 or the screen of the app operating on the communication terminal 10. When the PC screen toggle button 212 is on, the desktop screen is recorded.

When the user desires to record a screen of an app, the user further selects the app in an app selection field 213. The app selection field 213 displays names of apps being executed by the communication terminal 10 in a pull-down format. Thus, the app selection field 213 allows the user to select an app whose screen is to be recorded. The information recording app 41 acquires the names of the apps from the OS. The information recording app 41 can display names of apps that have a user interface (UI) (screen) among apps being executed. The apps to be selected may include the teleconference app 42. Thus, the information recording app 41 can record a material displayed by the teleconference app 42, the participant at each site, and the like as a moving image. The apps whose names are displayed in the pull-down format may include various apps being executed on the communication terminal 10 such as a presentation app, a word processor app, a spreadsheet app, a material creating and editing app for documents or the like, a cloud electronic whiteboard app, and a web browser app. This thus allows the user to flexibly select the screen of the app to be included in the combined moving image.

When recording is performed in units of apps, the user is allowed to select a plurality of apps. The information recording app 41 can record the screens of all the selected apps.

When both the camera toggle button 211 and the PC screen toggle button 212 are set off, “Only sound will be recorded” is displayed in a recording content confirmation window 214. The sound includes sound output from the communication terminal 10 (sound received by the teleconference app 42 from the second site 101) and sound collected by the meeting device 60. That is, when a teleconference is being held, the sound from the teleconference app 42 and the sound from the meeting device 60 are stored regardless of whether the images are recorded. Note that the user may make a setting to selectively stop storing the sound from the teleconference app 42 and the sound from the meeting device 60 according to user settings.

In accordance with a combination of on and off of the camera toggle button 211 and the PC screen toggle button 212, a combined moving image is recorded in the following manner. The combined moving image is displayed in real time in the recording content confirmation window 214.

If the camera toggle button 211 is on and the PC screen toggle button 212 is off, the panoramic image and the speaker images captured by the meeting device 60 are displayed in the recording content confirmation window 214.

If the camera toggle button 211 is off and the PC screen toggle button 212 is on (and the screen has also been selected), the desktop screen or the screen of the selected app is displayed in the recording content confirmation window 214.

If the camera toggle button 211 is on and the PC screen toggle button 212 is on, the panoramic image and the speaker images captured by the meeting device 60 and the desktop screen or the screen of the selected app are displayed side by side in the recording content confirmation window 214.

Thus, an image created by the information recording app 41 is referred to as a combined moving image for convenience in the present embodiment although there is a case where the panoramic image and the speaker images or the screen of the app is not recorded or a case where none of the panoramic image, the speaker image, and the screen of the app are recorded.

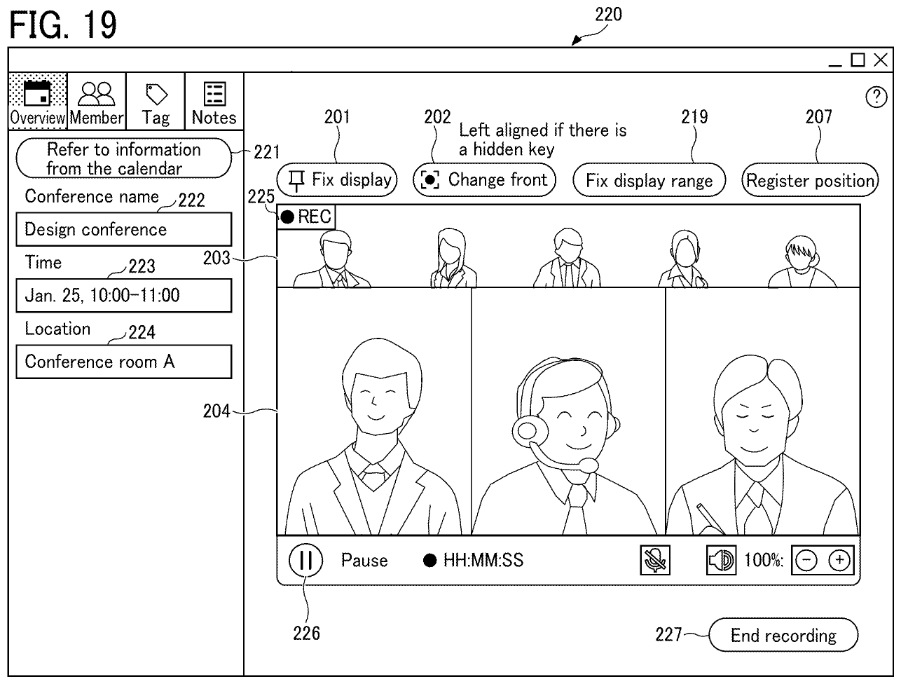

The recording setting screen 210 further includes a check box 215 with a message “Automatically create a transcript after uploading the record”. The recording setting screen 210 also includes a start recording now button 217. If the user checks a check box 209, text data converted from utterances made during the teleconference is attached to the recorded moving image. In this case, after the end of recording, the information recording app 41 uploads audio data to the information processing system 50 together with a text data conversion request. In response to the user pressing the start recording now button 217, a recording-in-progress screen 220 in FIG. 19 is displayed.

FIG. 19 is an example of the recording-in-progress screen 220 displayed by the information recording app 41 during recording. In FIG. 19, differences from FIG. 17 will be mainly described. The recording-in-progress screen 220 displays, in real time, the combined moving image being recorded according to the conditions set by the user in the recording setting screen 210. The recording-in-progress screen 220 in FIG. 19 corresponds to the case where the camera toggle button 211 is on and the PC screen toggle button 212 is off, and displays the panoramic image 203 and the talker images 204 (both of which are moving images) created by the meeting device 60. The recording-in-progress screen 220 displays a recording icon 225, a pause button 226, and a recording end button 227.

The pause button 226 is a button for pausing the recording. The pause button 226 also receives an operation of resuming the recording after the recording is paused. The recording end button 227 is a button for ending the recording. The recorded video ID is does not changed when the pause button 226 is pressed, whereas the recorded video ID is changed when the recording end button 227 is pressed. After pausing or temporarily stopping the recording, the user allowed to set the recording conditions set in the recording setting screen 210 again before resuming the recording or starting recording again. In this case, the information recording app 41 may create a plurality of recorded files each time the recording is stopped (for example, when the recording end button 227 is pressed), or may combine a plurality of files to create one continuous moving image (for example, when the pause button 226 is pressed). When the information recording app 41 plays the combined moving image, the information recording app 41 may play the plurality of recorded files continuously as one moving image.

The recording-in-progress screen 220 includes an acquire-information-from-calendar button 221, a conference name field 222, a time field 223, and a location field 224. The acquire-information-from-calendar button 221 is a button with which the user acquires conference information from the conference management system 9. In response to pressing of the acquire-information-from-calendar button 221, the information recording app 41 acquires a list of conferences for which the user has a right to view from the information processing system 50 and displays the list of conferences. The user selects a teleconference to be held from the list of conferences. Consequently, the conference information is reflected in the conference name field 222, the time field 223, and the location field 224. The title, the start time and the end time, and the location included in the conference information are reflected in the conference name field 222, the time field 223, and the location field 224, respectively. The conference information and the record in the conference management system 9 are associated with each other by the conference ID.

In response the user ending the recording after the end of the teleconference, a combined moving image with sound is created.

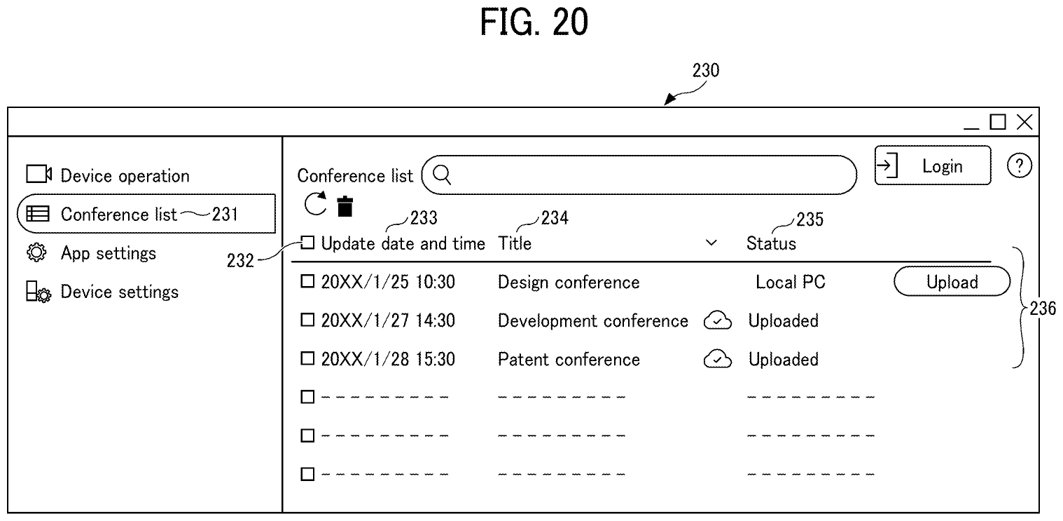

FIG. 20 is an example of a conference list screen 230 displayed by the information recording app 41. The conference list screen 230 displays a list of conferences, specifically, a list of pieces of record recorded during teleconferences. The list of conferences includes conferences held in a certain conference room as well as teleconferences.

The conference list screen 230 displays conference information for which the logged-in user has a right to view in the conference information storage unit 5001. The information on the recorded video stored in the information storage unit 1001 may be further integrated.

The conference list screen 230 is displayed in response to the user selecting a conference list tab 231 in the initial screen 200 in FIG. 17. The conference list screen 230 displays a list 236 of pieces of record for which the user has a right to view. The conference creator (minutes creator) can set the right to view for a participant of the conference. The list of conferences may be a list of stored pieces of record, a list of scheduled conferences, a list of pieces of conference data.

The conference list screen 230 includes items such as a check box 232, an update date and time 233, a title 234, and a status 235.

The check box 232 receives selection of a recorded file. The check box 232 is used when the user desires to collectively delete the recorded files.

The update date and time 233 indicates a recording start time or a recording end time of the combined moving image. If the combined moving image is edited, the update date and time 233 indicates the edited date and time.

The title 234 indicates the title (such as a subject) of the conference. The title may be transcribed from the conference information or set by the user.

The status 235 indicates whether the combined moving image has been uploaded to the information processing system 50. If the combined moving image has not been uploaded, “Local PC” is displayed, whereas if the combined moving image has been uploaded, “Uploaded” is displayed. If the combined moving image has not been uploaded, an upload button is displayed. If there is a combined moving image yet to be uploaded, it is desirable that the information recording app 41 automatically upload the combined moving image when the user logs into the information processing system 50.

In response to the user selecting a title or the like from the list 236 of the combined moving images with a pointing device, the information recording app 41 displays a recording/playback screen, description of which is omitted in the present embodiment. The recording/playback screen allows playback of the combined moving image.

It is desirable that the user be allowed to narrow down conferences based on the update date and time, the title, the keyword, or the like. If the user has a difficulty finding a conference of interest because many conferences are displayed, it is desirable that the user be allowed to input a word or phrase to narrow down the record based the word or phrase included in utterances made during the conference or the title of the conference with a search function. The search function allows the user to find desired record in a short time even if the number of pieces of recorded information increases. In the conference list screen 230, the user may be allowed to perform sorting by the update date and time or the title.

Operations or Processes

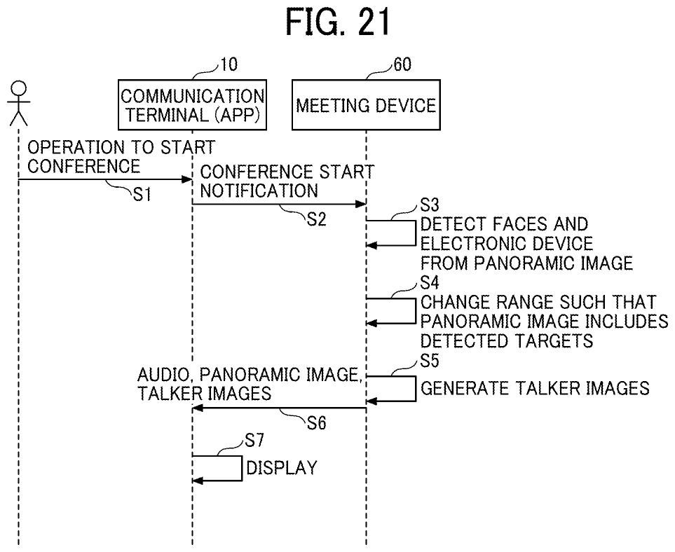

FIG. 21 is a sequence diagram illustrating an example of a process from the start of a conference to creation of the panoramic image 203 by the meeting device 60.

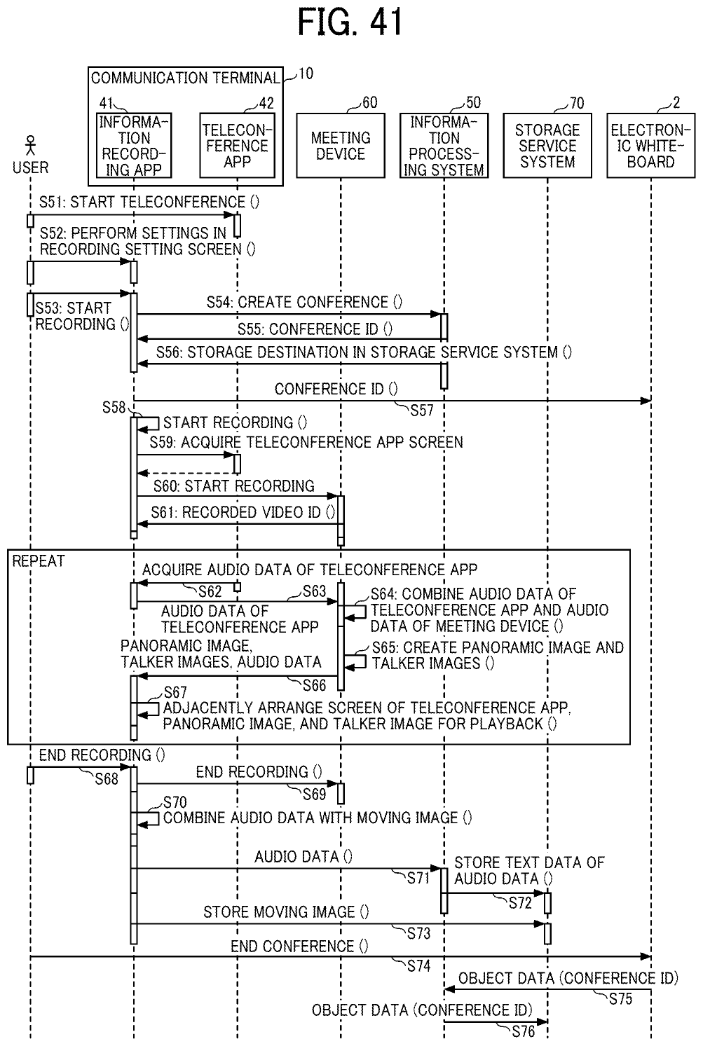

S1: The user performs an operation to start a conference in the information recording app 41. Note that a so-called teleconference is started in response to the teleconference app 42 establishing a connection to the second site 101. Starting the conference in step S1 means starting recording (pressing of the start recording now button 217). Details of creation of the record will be described in FIG. 41.

S2: The operation reception unit 12 of the information recording app 41 receives the user operation, and the device communication unit 16 transmits a conference start notification to the meeting device 60.

S3: The terminal communication unit 61 of the meeting device 60 receives the conference start notification. The participant detection unit 66 detects a participant (target). The sound direction detection unit 67, the code analysis unit 68, or the device recognition unit 69 detects the device direction of the electronic whiteboard 2 (target). A method of detecting the direction of the device will be described later.

S4: The first image generation unit 62 determines the height of the panoramic image 203 such that the panoramic image 203 includes the detected participants and the electronic whiteboard 2, and generates the panoramic image 203 such that the panoramic image 203 includes standing participants and the electronic whiteboard 2. If the electronic whiteboard 2 is not in the conference room, the first image generation unit 62 generates the panoramic image 203 including the participants of the conference.

S5: The second image generation unit 63 generates one or more talker images 204 from the panoramic image 203.

S6: The terminal communication unit 61 of the meeting device 60 transmits the panoramic image 203 and the talker images 204 to the communication terminal 10. The terminal communication unit 61 also transmits the audio data collected by the meeting device 60 or the mixed audio data described in FIG. 1 to the communication terminal 10.

S7: The device communication unit 16 of the information recording app 41 receives the panoramic image 203, the talker images 204, and the audio data. The recording control unit 17 generates a combined moving image. The display control unit 13 displays the combined image. In response to the end of recording, the recording control unit 17 transmits the combined moving image (with the audio data) to the storage service system 70, and the audio data processing unit 18 transmits a request for converting the audio data into text data to the information processing system 50. The information processing system 50 transmits the resultant text data to the storage service system 70. The combined moving image and the text data are preferably associated with each other by the conference ID and stored in the same URL or the like.

Example of Determination of Height of Panoramic Image

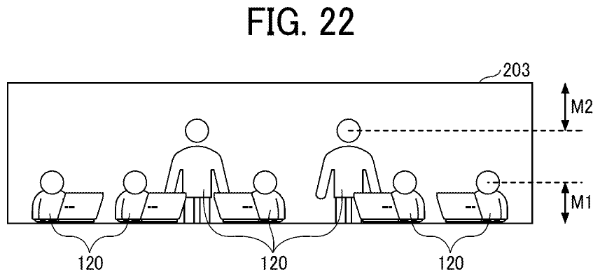

FIG. 22 illustrates an example of a height of the panoramic image 203 determined in response to detection of faces of the participants 120. The first image generation unit 62 sets a margin M1 for the face at the lowest position sets a margin M2 for the face at the highest position to determine the height of the panoramic image 203. In this example, the margin M1 extends down from the center of the face detected, and the margin M2 extends up from the center of the face detected. For example, the first image generation unit 62 increases the height of the panoramic image 203 from an initial setting height. The margins M1 and M2 are set as appropriate. For example, the margins M1 and M2 may be fixed values, one to three times the height of the face at the highest or lowest position, or the like.

When neither the participant nor the electronic whiteboard 2 is detected, the first image generation unit 62 generates the panoramic image 203 having the initial setting height that is set in advance.

Determination of Direction of Electronic Whiteboard in Panoramic Image

Methods of determining the direction of the electronic whiteboard 2 in the panoramic image 203 will be described. Four major methods for determining the direction of the electronic whiteboard 2 are as follows:
1. A user designates the direction of the electronic whiteboard 2 from the panoramic image 203 at the start of a conference;
2. The electronic whiteboard 2 displays a specific image (such as a two-dimensional code), and the communication terminal 10 or the meeting device 60 recognizes the specific image from the panoramic image 203 captured by the image-capturer 601 of the meeting device 60;
3. The electronic whiteboard 2 outputs a specific sound, and the meeting device 60 recognizes the specific sound with the microphone 608; and
4. Any information processing apparatus learns the shape of the electronic whiteboard 2 through machine learning, and the communication terminal 10 or the meeting device 60 recognizes the electronic whiteboard 2 from the panoramic image 203 captured by a camera (the image-capturer 601) of the meeting device 60.

1. User Designating Direction of Electronic Whiteboard 2 from Panoramic Image at Start of Conference

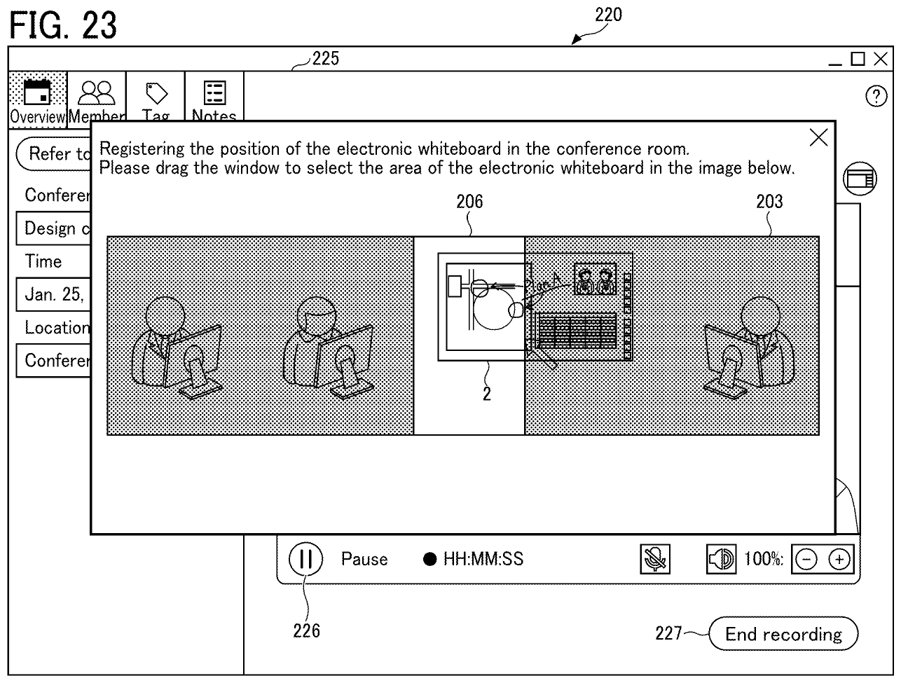

FIG. 23 is a diagram illustrating a method of an operation of setting the direction of the electronic whiteboard 2 through pressing of the position registration button 207. In response to pressing of the position registration button 207, the panoramic image 203 pops up. For example, the user moves a rectangular window 206 over the panoramic image 203 with a pointing device such as a mouse or a touch panel. The user aligns the window 206 over the electronic whiteboard 2, a podium, or the like included in the panoramic image 203.

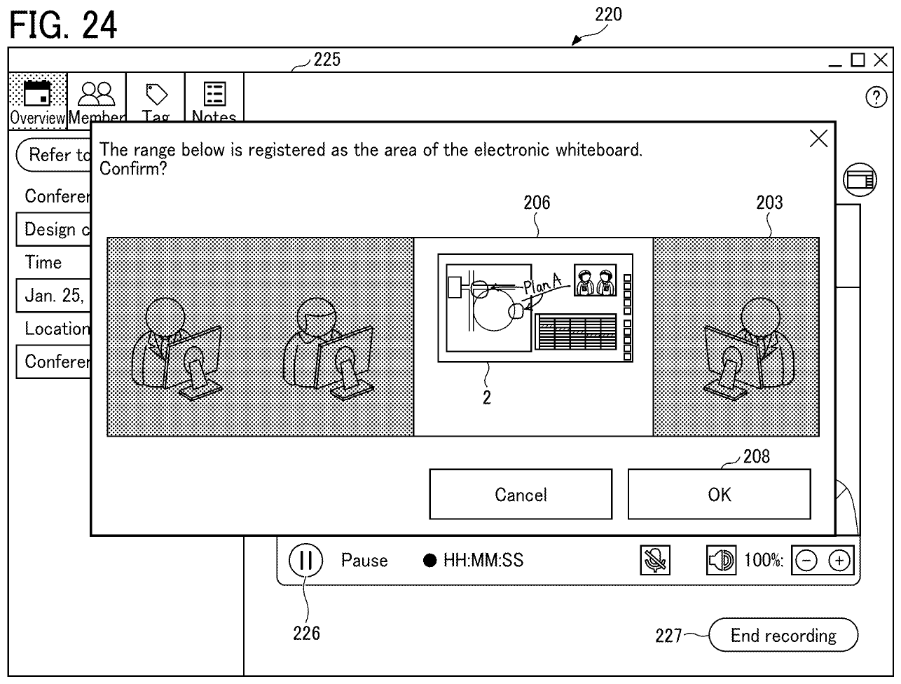

FIG. 24 illustrates a screen for checking the direction set by the user. In response to the user pressing an OK button 208, the direction of the electronic whiteboard 2 in the panoramic image 203 is set. The direction set by the user is transmitted to the meeting device 60, and stored by the first image generation unit 62 of the meeting device 60.

2. Electronic Whiteboard 2 Displaying Specific Image (Such as Two-Dimensional Code), and Terminal Apparatus 10 or Meeting Device 60 Recognizing Specific Image from Panoramic Image 203 Captured by Image-Capturer of Meeting Device 60, and 3. Electronic

Whiteboard 2 Outputting Specific Sound, and Meeting Device 60 Recognizing Sound with Microphone

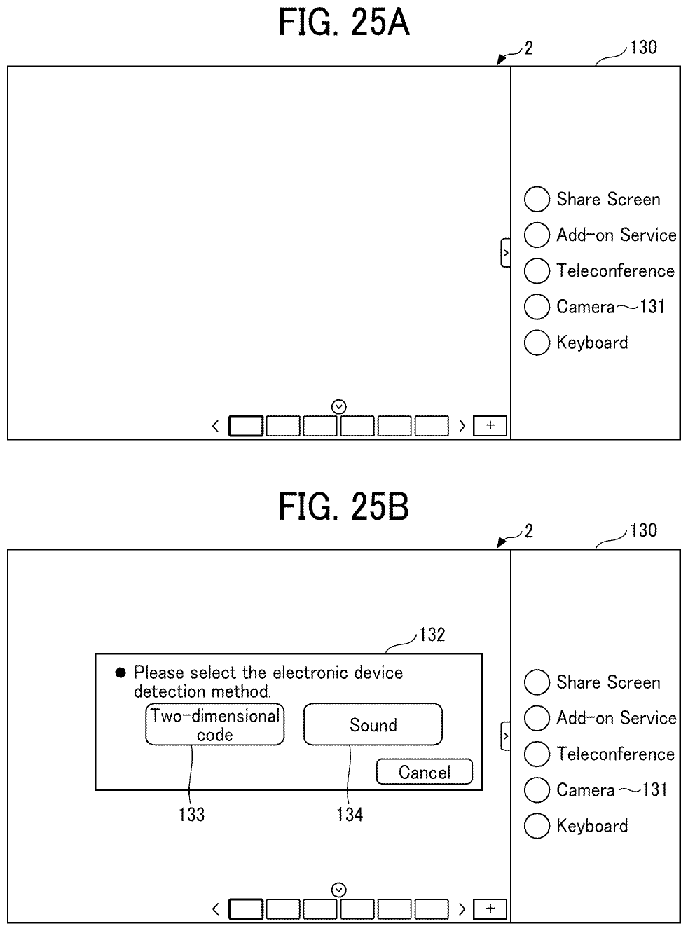

FIGS. 25A and 25B are diagrams illustrating an example of a screen, displayed by the electronic whiteboard 2, for setting a method of detecting the direction of the electronic whiteboard 2. FIG. 25A illustrates an example of a menu screen 130. The menu screen 130 includes a camera button 131. In response to the camera button 131 being pressed, a detection method setting window 132 is displayed.

FIG. 25B illustrates an example of the detection method setting window 132. The detection method setting window 132 includes a two-dimensional code button 133 and a sound button 134. In response to the two-dimensional code button 133 being pressed, the electronic whiteboard 2 displays the two-dimensional code. In response to the sound button 134 being pressed, the electronic whiteboard 2 outputs the specific sound.

Determination of Direction based on Two-Dimensional Code FIG. 26 illustrates an example of a two-dimensional code 301 displayed as the specific image by the electronic whiteboard 2.

In FIG. 26, the panoramic image 203 includes the electronic whiteboard 2, and the electronic whiteboard 2 displays the one two-dimensional code 301. The code analysis unit 68 detects the two-dimensional code 301 from the panoramic image 203. The code analysis unit 68 determines a position that is above the upper end of the two-dimensional code 301 by a height 302 of the two-dimensional code 301, as the upper end of the panoramic image 203. The two-dimensional code 301 includes the device identification information of the electronic whiteboard 2, so that the electronic whiteboard 2 and the meeting device 60 are associated with each other.

Determination of Direction based on Sound

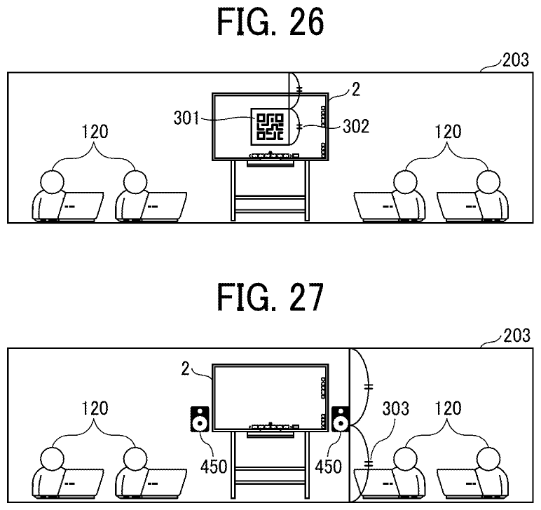

FIG. 27 is a diagram illustrating a method of determining the direction of the electronic whiteboard 2 based on the specific sound output by the electronic whiteboard 2. As illustrated in FIG. 27, the speakers 450 are installed at the left and right ends of the electronic whiteboard 2. The speakers 450 may be built in the right and left ends.

The audio data generation unit 37 outputs a sound from each of the speakers 450. The sound collection unit 64 automatically collects the sound of a specific frequency. The sound direction detection unit 67 performs Fourier transform on the audio data to obtain a frequency spectrum, and identifies two directions from which a sound having the frequency determined in advance and has a volume equal to or higher than a threshold arrives. In this way, the sound direction detection unit 67 identifies from which direction the sound emitted from each of the speakers 450 comes to the meeting device 60. The sound direction detection unit 67 determines the center of the speaker 450, and determines a height that is twice a height 303 of the speaker 450 as the height of the panoramic image 203.

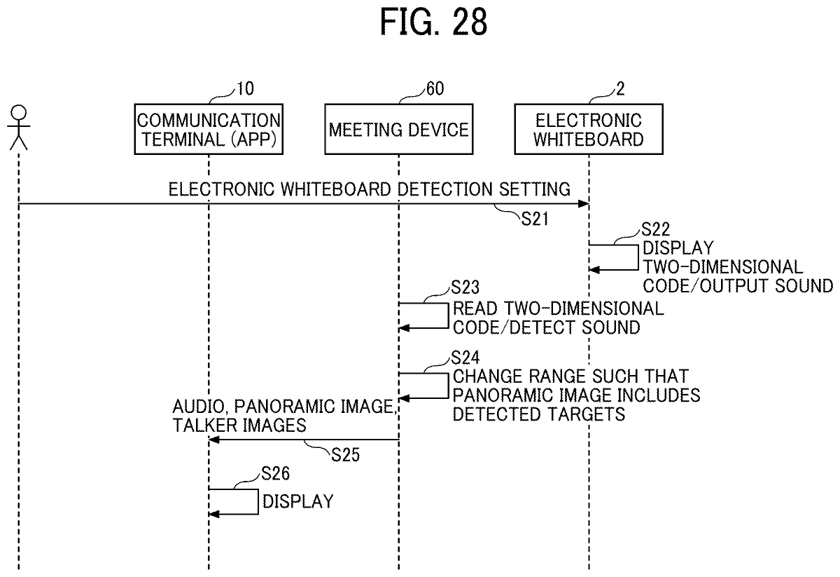

FIG. 28 is an example of a sequence diagram illustrating a process in which the meeting device 60 generates the panoramic image 203 including the electronic whiteboard 2, based on the specific image and the specific sound.

S21: The user presses the two-dimensional code button 133 or the sound button 134 in the detection method setting window 132. The operation reception unit 12 receives the pressing operation.

S22: The code generation unit 35 of the electronic whiteboard 2 generates a two-dimensional code serving as the specific image. The display control unit 34 displays the two-dimensional code on the display 480. The audio data generation unit 37 of the electronic whiteboard 2 outputs a sound of a specific frequency from the speakers 450. In one example, one of the code generation unit 35 and the audio data generation unit 37 operates. In another example, both of the code generation unit 35 and the audio data generation unit 37 operate.

S23: Since the meeting device 60 repeatedly captures an image of the surrounding space, the code analysis unit 68 detects the two-dimensional code if the two-dimensional code is in the angle of view. The code analysis unit 68 notifies the first image generation unit 62 of the position of the two-dimensional code. Since the sound collection unit 64 of the meeting device 60 repeatedly collects a sound, the sound collection unit 64 automatically collects the sound of the specific frequency. The sound direction detection unit 67 performs Fourier transform on the audio data to obtain a frequency spectrum, and identifies two directions from which a sound having the frequency determined in advance and has a volume equal to or higher than a threshold arrives. The sound direction detection unit 67 converts the direction of the speaker 450 of the electronic whiteboard 2 (the latitude and the longitude in the spherical image) into the position in the panoramic image, and notifies the first image generation unit 62 of the position. The specific sound is preferably in an ultrasonic frequency band because the sound in the ultrasonic frequency band is non-audible to the user.

S24: The first image generation unit 62 determines the height of the panoramic image 203 based on the two-dimensional code or determines the height of the panoramic image 203 based on the direction of the speaker 450 of the electronic whiteboard 2. The first image generation unit 62 generates the panoramic image 203 having the determined height from the spherical image.

S25: The terminal communication unit 61 of the meeting device 60 transmits the panoramic image 203, the talker images 204, and the audio data to the communication terminal 10.

S26: The device communication unit 16 of the information recording app 41 receives the panoramic image 203, the talker images 204, and the audio data. The recording control unit 17 combines the panoramic image 203 and the talker images 204 together to generate a combined moving image. The display control unit 13 displays the combined image.

4. Any Information Processing Apparatus Learning Shape of Electronic Whiteboard Through Machine Learning, and Terminal Apparatus or Meeting Device Recognizing Electronic Whiteboard from Panoramic Image Captured by Image-Capturer of Meeting Device

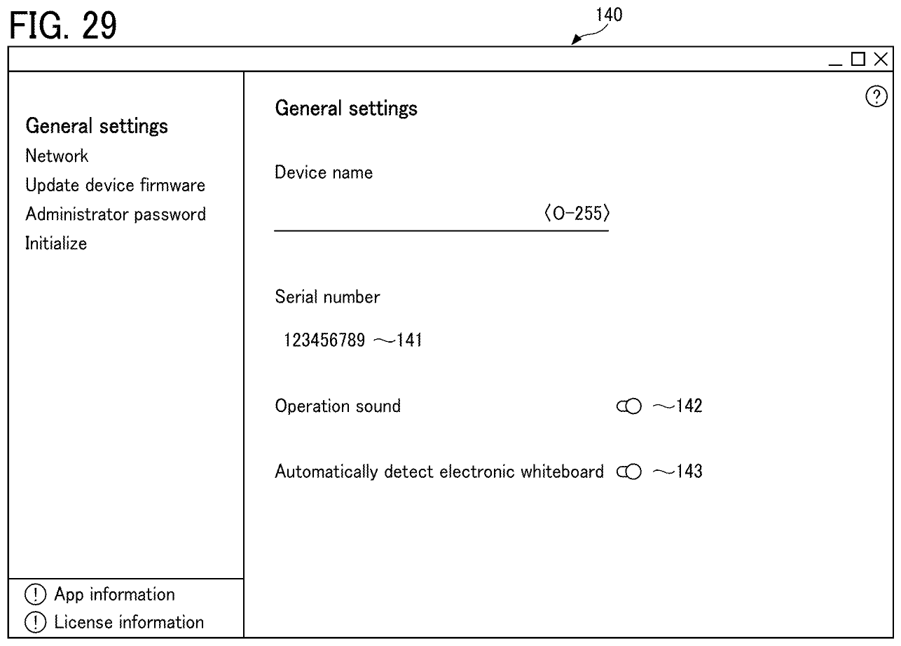

FIG. 29 illustrates an example of an automatic detection setting screen 140 for the electronic whiteboard 2, displayed by the information recording app 41. The automatic detection setting screen 140 includes a serial number field 141, an operation sound toggle button 142, and an automatic detection toggle button 143. The serial number field 141 displays the serial number (device identification information) transmitted by the meeting device 60. The operation sound toggle button 142 is a button for setting whether to output sound that indicates reception of the user operation by the information recording app 41. The automatic detection toggle button 143 is a button for enabling or disabling automatic detection of the electronic whiteboard 2 by the meeting device 60.

In response to the user pressing the automatic detection toggle button 143, the information recording app 41 transmits a request to automatically detect the electronic whiteboard 2 to the meeting device 60. The meeting device 60 detects the electronic whiteboard 2 from the spherical image.

FIG. 30 is a diagram illustrating an example of the electronic whiteboard 2 detected through image processing such as machine learning;

The device recognition unit 69 detects a shape (circumscribed rectangle) 241 of the electronic whiteboard 2 from the spherical image through machine learning.

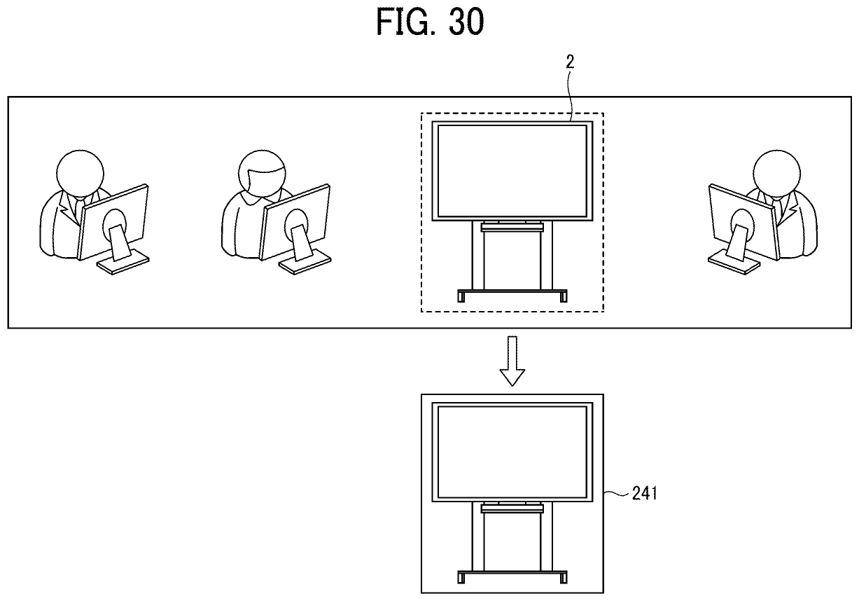

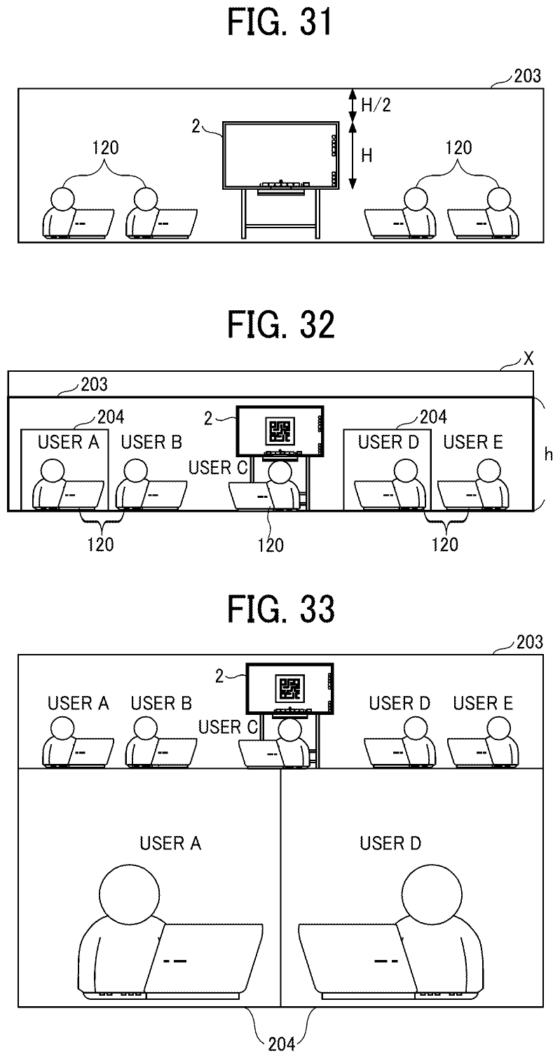

FIG. 31 is a diagram illustrating an example of the height of the panoramic image 203 determined based on the electronic whiteboard 2 detected through image processing. In one example, in response to the electronic whiteboard 2 being detected from the spherical image, the first image generation unit 62 determines a height that is above the upper end of the electronic whiteboard 2 by a half the height H of the electronic whiteboard 2, as the height of the panoramic image 203. In other words, a margin calculated as the half of the height H of the electronic whiteboard 2 is added above the electronic whiteboard 2. A distance (margin) from the upper end of the electronic whiteboard 2 to the upper end of the panoramic image 203 may be 0 or may be a value such as ⅓ to ¼ of the height H of the electronic whiteboard 2. A half the height H of the electronic whiteboard 2 is merely an example.

Example of Generation of Panoramic Image

FIG. 32 is a diagram illustrating an example method of generating the panoramic image 203 from a spherical image. The first image generation unit 62 clips a panoramic image in the lateral direction from a spherical image X such that the panoramic image includes the participants 120 and the electronic whiteboard 2. The spherical image X has a three-dimensional structure. Thus, if the spherical image X is represented by a flat surface as in FIG. 32, the resultant image curves. However, the image is simplified for ease of understanding in FIG. 32. The first image generation unit 62 changes the angles “a degrees” and “b degrees” illustrated in FIG. 6B such that the panoramic image includes the participants 120 and the electronic whiteboard 2. The horizontal-direction clipping range may be 360 degrees. However, as described below, the panoramic image is desirably clipped to include the participants 120 and the electronic whiteboard 2 also in the horizontal direction. Accordingly, the height h and the width w of the panoramic image 203 are variable.

The participant detection unit 66 and the device recognition unit 69 register the objects detected according to the detection setting in, for example, a database, and determine whether or not the registered detected objects are still detected from the panoramic image 203 output as a moving image with reference to the database. If the participant 120 or the electronic whiteboard 2 that has been detected is no longer detected in the panoramic image 203 for a certain period (a part of the plurality of targets has disappeared from the first image), the first image generation unit 62 adjusts the range of the panoramic image 203 again such that the panoramic image 203 also includes the disappeared participant 120 or the disappeared electronic whiteboard 2.

The second image generation unit 63 clips the images of the talkers from the panoramic image 203 generated by the first image generation unit 62, to generate the talker images 204. In FIG. 32, the talker image 204 including a user A and the talker image 204 including a user D are generated.

FIG. 33 illustrates an example of a combined image displayed by the information recording app 41. The panoramic image 203 is displayed in an upper portion of the combined image. The talker images 204 are displayed below the panoramic image 203.

The arrangement and the number of talker images 204 are merely an example.

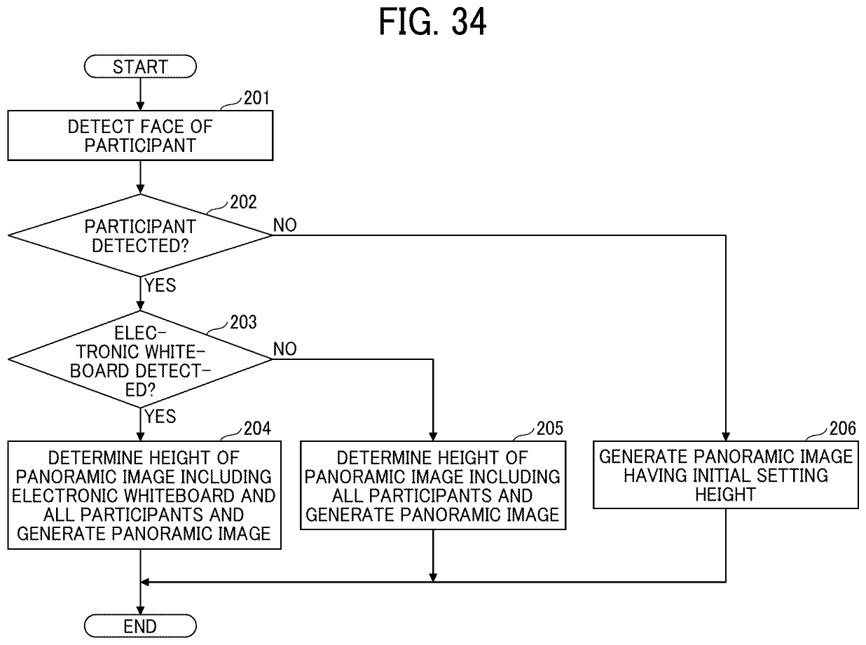

FIG. 34 is a flowchart of an example illustrating a process in which the first image generation unit 62 determines the height of the panoramic image 203.

During a conference, the meeting device 60 repeatedly captures the spherical image X. The participant detection unit 66 of the meeting device 60 performs face recognition or the like on the spherical image X to detect the participants 120 (S201).

If no participant 120 is detected (No in S202), the electronic whiteboard 2 does not display any object (because the electronic whiteboard 2 is not operated). Thus, the first image generation unit 62 generates the panoramic image 203 having the initial setting height (S206).

If the participant 120 is detected (Yes in S202), it is determined whether the sound direction detection unit 67, the code analysis unit 68, or the device recognition unit 69 of the meeting device 60 has detected the electronic whiteboard 2 from the spherical image X (S203).

Note that it may be determined whether the operation detection unit 38 has detected an operation on the electronic whiteboard 2. The communication unit 36 of the electronic whiteboard 2 transmits the presence or absence of an operation to the communication terminal all the time. The communication terminal 10 and the electronic whiteboard 2 are allowed to communicate with each other if the communication terminal 10 and the electronic whiteboard 2 are in the same LAN and the communication terminal 10 is informed of the IP address (included in the two-dimensional code, for example) of the electronic whiteboard 2. The communication terminal 10 and the electronic whiteboard 2 are participating in the same conference. Thus, the information processing system 50 may refer to the association information and transmit the presence or absence of an operation to the communication terminal 10 based on the conference ID. This allows the first image generation unit 62 to determine the height of the panoramic image 203 such that the panoramic image 203 includes the electronic whiteboard 2 in a case where the electronic whiteboard 2 is operated.

If the electronic whiteboard 2 is detected (Yes in S203), the first image generation unit 62 generates the panoramic image 203 having a height such that the panoramic image 203 includes the electronic whiteboard 2 and all the participants 120 (S204). For example, the first image generation unit 62 adopts a higher one of the height of the panoramic image 203 determined based on the electronic whiteboard 2 and the height of the panoramic image 203 determined based on the participants 120.

If the electronic whiteboard 2 is not detected (No in S203), the first image generation unit 62 generates the panoramic image 203 having a height such that the panoramic image 203 includes all the participants 120 (S205).

As described above, the first image generation unit 62 successfully generates the panoramic image 203 such that the panoramic image 203 includes the electronic whiteboard 2 and all the participants 120 in response to detection of faces of the participants 120 and an operation on the electronic whiteboard 2.

Centering of Electronic Whiteboard

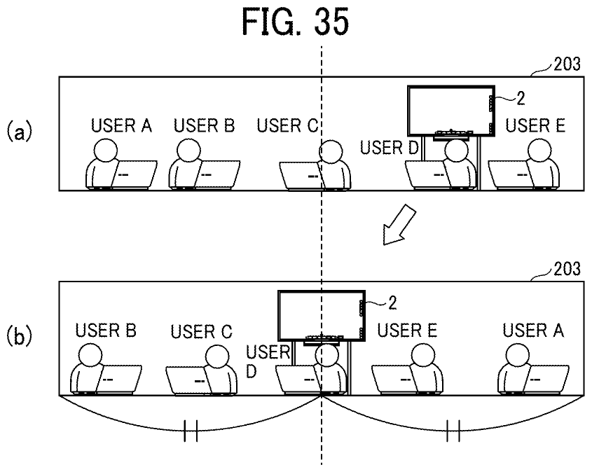

FIG. 35 illustrates the electronic whiteboard 2 arranged at the center of the panoramic image 203. Part (a) of FIG. 35 illustrates the panoramic image 203 in which the front area of the meeting device 60 is at the center. As illustrated in part (b) of FIG. 35, in response to detection of the electronic whiteboard 2, the first image generation unit 62 places the electronic whiteboard 2 at the center (in the width direction) of the panoramic image 203. The first image generation unit 62 may move the electronic whiteboard 2 from the right to the left to be at the center of the panoramic image 203 and combines a left end image having a width equivalent to the movement to the right end of the panoramic image 203 (the moving direction may be opposite). Arrangement of the electronic whiteboard 2 at the center of the panoramic image 203 makes it easier for the users to check the content displayed on the electronic whiteboard 2.

Display Example of Panoramic Image

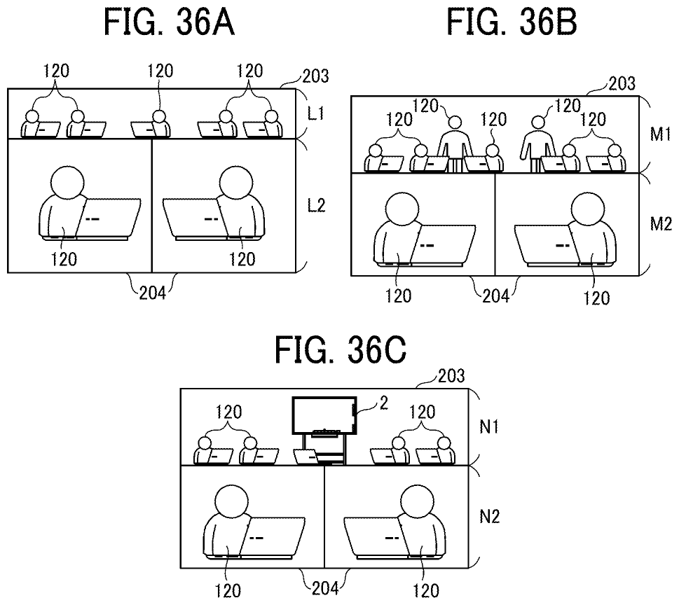

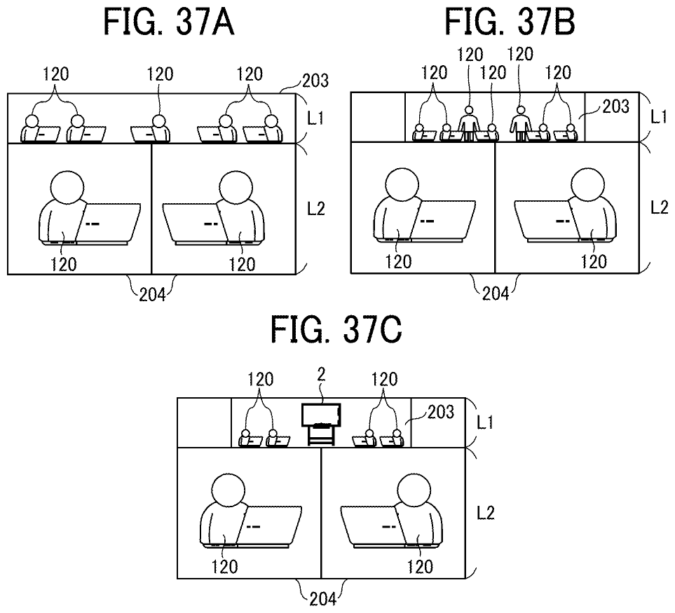

An effect of the display range fixing button 219 will be described next with reference to FIGS. 36A to 37C. FIGS. 36A, 36B, and 36C each illustrate an example of the panoramic image 203 generated when the display range fixing button 219 is off. In FIGS. 36A, 36B, and 36C, one panoramic image 203 and two talker images 204 are arranged and displayed in one screen. The number of talker images 204 is merely an example. No talker image 204 may be displayed, or three or more talker images 204 may be displayed.

FIG. 36A illustrates the panoramic image 203 in which all the participants 120 are seated. In this case, the panoramic image 203 has the height L1 and the talker images 204 have the height L2.

FIG. 36B illustrates the panoramic image 203 in the case where some of the participants 120 are standing. The first image generation unit 62 increases the height of the panoramic image 203 such that the panoramic image 203 includes faces of all the participants 120. In FIG. 36B, the panoramic image 203 has the height M1 and the talker images 204 have the height M2. The display control unit 13 of the information recording app 41 enlarges a display area for the panoramic image 203 (an example of a display area for the first image) on the screen of the communication terminal 10, to be larger than or equal to the panoramic image 203 such that the participants 120 are included.

When the size of the entire combined image displayed by the information recording app 41 is set to a fixed value, the second image generation unit 63 changes the height of the talker images 204 in accordance with the height of the panoramic image 203.

That is, when L1+L2 denotes the height of the combined image and M1 denotes the height of the panoramic image 203, the height of the talker images 204 is L1+L2-M1=M2. The second image generation unit 63 just performs trimming to reduce the height of the talker images 204. In another example, the second image generation unit 63 may perform trimming additionally in the width direction such that the aspect ratio of the talker images 204 is constant. The second image generation unit 63 may reduce the size of the talker images 204.

Thus, the heights L1, L2, M1, and M2 have the following relationships.

L1<M1,L2>M2

FIG. 36C illustrates the panoramic image 203 created such that the panoramic image 203 includes the electronic whiteboard 2. The first image generation unit 62 increases the height of the panoramic image 203 such that the panoramic image 203 includes faces of all the participants 120 and the electronic whiteboard 2. For example, the first image generation unit 62 detects faces of the respective participants 120 and the electronic whiteboard 2 and determines the height of the panoramic image 203 such that the panoramic image 203 includes the faces of all the participants 120 and the electronic whiteboard 2. The talker images 204 are substantially the same as those in FIG. 36B. In FIG. 36C, the panoramic image 203 has the height N1 and the talker images 204 have the height N2. Thus, the heights L1, L2, N1, and N2 have the following relationships.

L1<N1,L2>N2

As described above, when the display range fixing button 219 is off (i.e., display area for the first image is not set to a fixed value), the information recording app 41 is allowed to display the panoramic image 203 in a larger size.

FIGS. 37A, 37B, and 37C each illustrate an example of the panoramic image 203 generated when the display range fixing button 219 is on. FIG. 37A is the same as FIG. 36A.

FIG. 37B illustrates the panoramic image 203 in the case where some of the participants 120 are standing. The first image generation unit 62 increases, in the wide-angle image captured by the meeting device 60, the height of the range from which the panoramic image 203 is generated such that the panoramic image 203 includes faces of all the participants 120. As a result, the panoramic image 203 has an increased area (i.e., increased height). The first image generation unit 62 then reduces the size of the panoramic image 203 while maintaining the aspect ratio after the height of the range for the panoramic image 203 is changed such that the entire panoramic image 203 fits the height L1.

Since the height of the panoramic image 203 in FIG. 37B is unchanged from that in FIG. 37A, L1 is constant. The height L2 of the talker images 204 is also constant. The information recording app 41 may perform this size reduction.

FIG. 37C illustrates the panoramic image 203 created such that the panoramic image 203 includes the electronic whiteboard 2. The first image generation unit 62 increases, in the wide-angle image captured by the meeting device 60, the height of the range from which the panoramic image 203 is generated such that the panoramic image 203 includes faces of all the participants 120 and the electronic whiteboard 2. As a result, the panoramic image 203 has an increased height. Then, the first image generation unit 62 reduces the size of the panoramic image 203 while maintaining the aspect ratio of the panoramic image 203 after the height of the range for the panoramic image 203 is changed such that the entire panoramic image 203 fits the height L1.

Since the height of the panoramic image 203 in FIG. 37C is unchanged from that in FIG. 37A, L1 is constant. The height L2 of the talker images 204 is also constant. The information recording app 41 may perform this size reduction.

As described above, when the display range fixing button 219 is on, the panoramic image 203 displayed by the information recording app 41 is successfully maintained to be constant.

The communication terminal 10 may perform the processing described in FIG. 36A to 37C.

Generation of Panoramic Image in Accordance with on/Off of Display Range Fixing Button

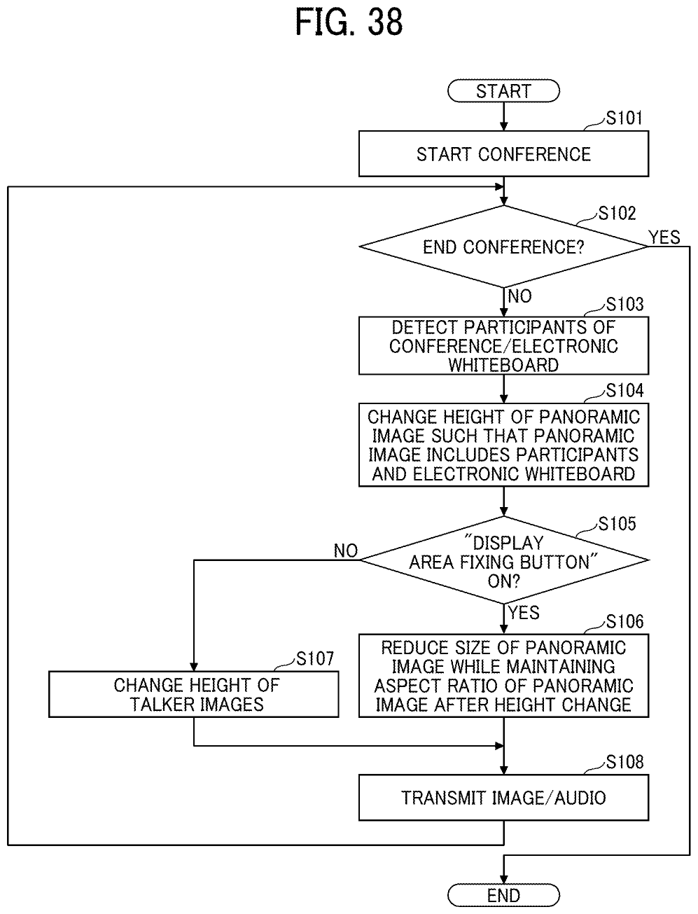

FIG. 38 is an example of a flowchart for describing a process in which the first image generation unit 62 generates the panoramic image 203 when the display range fixing button 219 is on or off.

During a period from when a conference starts (S101) to when the conference ends (S102), the participant detection unit 66 detects the participants 120 from the spherical image and the sound direction detection unit 67, the code analysis unit 68, or the device recognition unit 69 detects the electronic whiteboard 2 (5103).

As described in FIG. 34, the first image generation unit 62 changes the height of the panoramic image 203 and generates the panoramic image 203 such that the panoramic image 203 includes the faces of the participants 120 and the electronic whiteboard 2 (5104).

The first image generation unit 62 determines whether the display range fixing button 219 in FIG. 17 is on (5105).

If the display range fixing button 219 is off (No in S105), the second image generation unit 63 changes the height of the talker images 204 in accordance with the height of the panoramic image 203 (S107).

If the display range fixing button 219 is on (Yes in S105), the first image generation unit 62 generates the panoramic image 203 such that the panoramic image 203 includes the faces of the participants 120 and the electronic whiteboard 2, which is the same as in the case where the display range fixing button 219 is off. However, the first image generation unit 62 then reduces the height and the width of the panoramic image 203 while maintaining the aspect ratio of the panoramic image 203 after the change of the height such that the height of the panoramic image 203 is equal to the initial setting height (S106). In this manner, the panoramic image 203 including the faces of the participants 120 and the electronic whiteboard 2 is successfully generated with the display area of the panoramic image 203 in the combined image unchanged. The second image generation unit 63 no longer performs trimming on the talker images 204.

The terminal communication unit 61 of the meeting device 60 transmits the panoramic image 203, the talker images 204, and the audio data to the communication terminal 10 (S108).

Determination of Width of Panoramic Image

In the embodiment described above, the height of the panoramic image 203 is determined such that the panoramic image 203 includes the participants 120 and the electronic whiteboard 2. However, if the panoramic image 203 generated by the meeting device 60 is an image of a part of 360-degree space in the horizontal direction, an inconvenience caused by the height occurs.

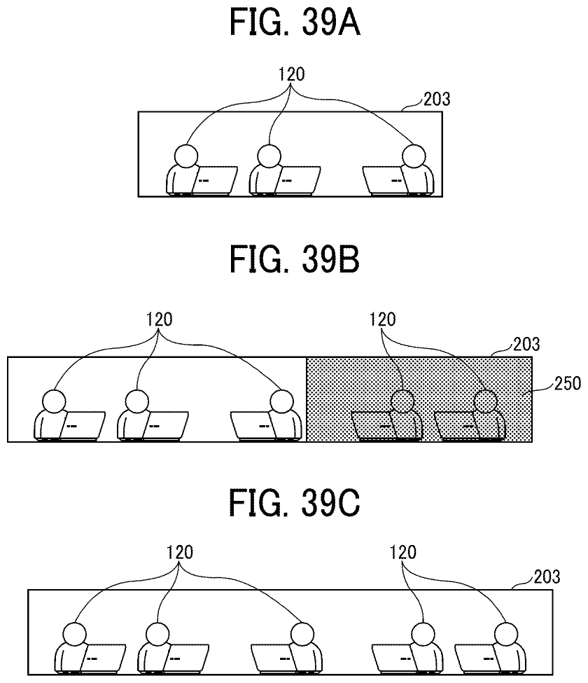

FIGS. 39A, 39B, and 39C each illustrate the panoramic image 203 from which a part of the panoramic image 203 in the horizontal direction is cut off. The meeting device 60 can capture an image of a 360-degree range in the horizontal direction. However, to reduce the processing load of image processing and transmission to the communication terminal 10 performed by the meeting device 60, the meeting device 60 may generate the panoramic image 203 of a partial space (of 180 degrees to 200 degrees including the front space, for example) in the horizontal direction. As illustrated in FIG. 39A, in a conference involving a small number of participants, all the participants 120 are included in the panoramic image 203 of the partial space in the horizontal direction.

However, as illustrated in FIG. 39B, in a conference involving a large number of participants, the panoramic image 203 of the partial space in the horizontal direction no longer includes all the participants 120. In FIG. 39B, the participants 120 are present in a hatched area 250 but are not included in the panoramic image 203. The information recording app 41 is unable to display the participants 120 not included in the panoramic image 203.

Accordingly, the first image generation unit 62 determines the width of the panoramic image 203 such that the panoramic image 203 includes all the participants 120 and the electronic whiteboard 2 in response to detection of the participants 120 or the electronic whiteboard 2. For example, the first image generation unit 62 provides a margin that is as large as the size of one or two faces to the face of the leftmost participant and the face of the rightmost participant 120 in the horizontal direction and determines the width of the panoramic image 203.

In this way, the first image generation unit 62 successfully generates the panoramic image 203 that includes all the participants 120 and the electronic whiteboard 2 also in the horizontal direction as illustrated in FIG. 39C. When the number of participants 120 is small, the processing load of the meeting device 60 is successfully reduced.

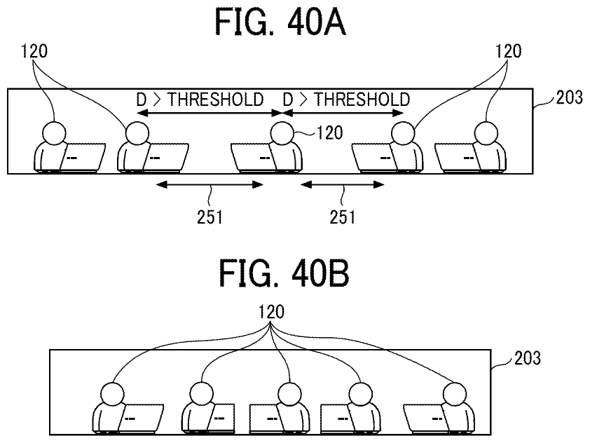

A case where a space is present between the participants 120 in the panoramic image 203 will be described next with reference to FIGS. 40A and 40B. FIGS. 40A and 40B are diagrams illustrating an example of a process of omitting an excessive space when a space is present between the participants 120 in the panoramic image 203. Even if the width of the panoramic image 203 is fixed or variable as in FIGS. 39A to 39C, a space is present between the participants 120 in the panoramic image 203 when the participants 120 are seated with a space between the participants 120.

Based on a determination that the space between the participants 120 or the space between the participant 120 and the electronic whiteboard 2 is greater than or equal to a threshold, the first image generation unit 62 omits an excessive space 251 between the participants 120 or between the participant 120 and the electronic whiteboard 2.

Omitting refers to deleting a portion of the panoramic image 203 equivalent to the excessive space 251. In FIG. 40A, two spaces D is greater than or equal to the threshold. In this case, for example, the first image generation unit 62 leaves a margin that is as large as the size of one to two faces of the participant 120, deletes the panoramic image 203 by the rest of the excessive space 251, and links the cut panoramic image 203 together.

FIG. 40B illustrates the panoramic image 203 without the excessive spaces 251. As a result of omitting the excessive spaces 251, the panoramic image 203 includes a less redundant space, leading to an improved browsability of the participants 120. Instead of determining whether the space D between the participants 120 or between the participant 120 and the electronic whiteboard 2 is greater than or equal to the threshold, the first image generation unit 62 may omit a portion of the panoramic image 203 such that the spaces between the participants 120 or between the participant 120 and the electronic whiteboard 2 are substantially equal.

Omitting Includes Reducing the Space D from 1 [m] to 0.5 [m]

Storage of Combined Moving Image

A process of storing a combined moving image will be described with reference to FIG. 41. FIG. 41 is an example of a sequence diagram illustrating a procedure in which the information recording app 41 records the panoramic image 203, the talker images 204, and a screen of an app.

S51: The user at the first site 102 operates the teleconference app 42 to start a teleconference. In this example, the teleconference app 42 at the first site 102 and the teleconference app 42 at the second site 101 start a teleconference. The teleconference app 42 at the first site 102 transmits an image captured by the camera of the communication terminal 10 and sound collected by the microphone of the communication terminal 10 to the teleconference app 42 at the second site 101. The teleconference app 42 at the second site 101 displays the received image on the display of the communication terminal 10 and outputs the received sound from the speaker of the communication terminal 10. Likewise, the teleconference app 42 at the second site 101 transmits an image captured by the camera of the communication terminal 10 and sound collected by the microphone of the communication terminal 10 to the teleconference app 42 at the first site 102. The teleconference app 42 at the first site 102 displays the received image on the display of the communication terminal 10 and the speaker of the communication terminal 10. The teleconference app 42 at the first site 102 and the teleconference app 42 at the second site 101 repeat this processing to implement the teleconference.

S52: The user at the first site 102 performs recording settings in the recording setting screen 210 of the information recording app 41 illustrated in FIG. 14. The operation reception unit 12 of the information recording app 41 receives the settings made by the user. In this example, both the camera toggle button 211 and the PC screen toggle button 212 are on.

If the teleconference is scheduled in advance, the user presses the acquire-information-from-calendar button 221 in FIG. 19 to display the list of conferences and selects the teleconference with which a moving image to be recorded is associated. Since the user has logged into the information processing system 50, the information processing system 50 identifies teleconferences for which the logged-in user has a right to view. The information processing system 50 transmits the list of the identified teleconferences to the communication terminal 10. Thus, the user selects a teleconference that is being held or to be held. In this way, information related to the teleconference such as the conference ID is determined.

If the teleconference is not scheduled in advance, the user is allowed to create the conference when creating a combined moving image. In the description below, the information recording app 41 creates a conference when creating a combined moving image and acquires the conference ID from the information processing system 50.

S53: The user instructs the information recording app 41 to start recording (through the start recording now button 217). The operation reception unit 12 of the information recording app 41 receives the instruction. The display control unit 13 displays the recording-in-progress screen 220.

S54: Since the teleconference is not selected (because the conference ID has not been determined), the communication unit 11 of the information recording app 41 transmits a teleconference creation request to the information processing system 50.

S55: The communication unit 51 of the information processing system 50 receives the teleconference creation request. The communication management unit 54 acquires the conference ID that is unique and assigned by the conference management system 9. The communication unit 51 transmits the conference ID to the information recording app 41.

S56: The communication management unit 54 transmits information on a storage destination (URL of the storage service system 70) of the combined moving image (moving image file) to the information recording app 41 via the communication unit 51.

S57: The communication unit 11 of the information recording app 41 receives the conference ID and the information on the storage destination of the moving image file. The communication unit 11 then transmits the conference ID to the electronic whiteboard 2. In one example, the communication unit 11 transmits the conference ID to the electronic whiteboard 2 via the information processing system 50. In another example, the communication unit transmits the conference ID directly to the electronic whiteboard 2.

S58: In response to the communication unit 11 of the information recording app 41 receiving the conference ID and the information on the storage destination of the moving image file, the recording control unit 17 determines that recording is ready to be started and starts recording.

S59: The app screen acquisition unit 14 of the information recording app 41 transmits a request for an app screen to an app selected by the user. Specifically, the app screen acquisition unit 14 acquires the app screen via the OS. In FIG. 41, the app selected by the user is the teleconference app 42.

S60: The recording control unit 17 of the information recording app 41 notifies the meeting device 60 of the start of recording via the device communication unit 16. It is desirable that the recording control unit 17 notify the meeting device 60 that the camera toggle button 211 is on (to request the panoramic image 203 and the talker images 204). The meeting device 60 transmits the panoramic image 203 and the talker images 204 to the information recording app 41 regardless of the presence or absence of the request.

S61: In response to the terminal communication unit 61 of the meeting device 60 receiving the recording start notification, the terminal communication unit 61 assigns a unique recorded video ID and returns the recorded video ID to the information recording app 41. The recorded video ID may be assigned by the information recording app 41, or may be acquired from the information processing system 50.

S62: The sound acquisition unit 15 of the information recording app 41 acquires audio data output by the communication terminal 10 (audio data received by the teleconference app 42).

S63: The device communication unit 16 transmits the audio data acquired by the sound acquisition unit 15 and a combination request to the meeting device 60.

S64: The terminal communication unit 61 of the meeting device 60 receives the audio data and the combination request, and the audio combining unit 65 combines the audio data of the surroundings collected by the sound collection unit 64 and the received audio data together. For example, the audio combining unit 65 adds up the two pieces of audio data. Since clear sound around the meeting device 60 is recorded, particularly the accuracy of text converted from the sound around the meeting device 60 (in the conference room) increases.

The communication terminal 10 may perform this combination of the audio data. However, if the recording function is deployed in the communication terminal 10 and the audio processing is deployed in the meeting device 60 in a distributed manner, the loads on the communication terminal 10 and the meeting device 60 are successfully reduced. In another example, the recording function may be deployed in the meeting device 60 and the audio processing may be deployed in the communication terminal 10 in a distributed manner.

S65: The first image generation unit 62 of the meeting device 60 creates the panoramic image 203, and the second image generation unit 63 creates the talker images 204. In step S65, the height of the panoramic image 203 is determined as described in the present embodiment.

S66: The device communication unit 16 of the information recording app 41 repeatedly acquires the panoramic image 203 and the talker images 204 from the meeting device 60. The device communication unit 16 repeatedly acquires the combined audio data from the meeting device 60. The device communication unit 16 may transmit a request to the meeting device 60 to acquire the images and the audio data. Alternatively, in response to receiving a notification indicating that the camera toggle button 211 is on, the meeting device 60 may automatically transmit the panoramic image 203 and the talker images 204. In response to receiving the combination request for the audio data, the meeting device 60 may automatically transmit the combined audio data to the information recording app 41.

S67: The recording control unit 17 of the information recording app 41 arranges the app screen acquired from the teleconference app 42, the panoramic image 203, and the talker images 204 adjacently with one another to create a combined image. The recording control unit 17 repeatedly creates the combined image and designates each combined image as a frame of a moving image to create a combined moving image. The recording control unit 17 stores the audio data received from the meeting device 60.

The information recording app 41 repeats steps S62 to S67 described above.

S68: If the teleconference ends and the recording is no longer desired, the user instructs the information recording app 41 to end recording (through the recording end button 227, for example). The operation reception unit 12 of the information recording app 41 receives the instruction.

S69: The device communication unit 16 of the information recording app 41 transmits a recording end notification to the meeting device 60. The meeting device 60 keeps creating the panoramic image 203 and the talker images 204 and combining the audio data. The meeting device 60 may change the processing load such as the resolution or the frame rate (fps) depending on whether recording is in progress.

S70: The recording control unit 17 of the information recording app 41 combines the audio data with the combined moving image to create the combined moving image with sound.

S71: If the user has checked the check box 215 “Automatically create a transcript after uploading the record” in the recording setting screen 210, the audio data processing unit 18 transmits a request to convert the audio data into text data to the information processing system 50.

Specifically, the audio data processing unit 18 designates the URL of the storage destination, and transmits, via the communication unit 11, a request to convert the audio data of the combined moving image along with the conference ID and the recorded video ID to the information processing system 50.

S72: The communication unit 51 of the information processing system 50 receives the request to convert the audio data, and the text conversion unit 56 uses the speech recognition service system 80 to convert the audio data into text data. The communication unit 51 stores the text data in the storage destination (indicated by the URL of the storage service system 70) that is the same as the storage destination of the combined moving image. The recorded video information storage unit 5002 stores the text data in association with the combined moving image by the conference ID and the recorded video ID. The communication management unit 54 of the information processing system 50 may manage and store the text data in the storage unit 5000. The communication terminal 10 may transmit a speech recognition request to the speech recognition service system 80 and store the text data acquired from the speech recognition service system 80 in the storage destination. The speech recognition service system 80 returns the converted text data to the information processing system 50. In another example, the speech recognition service system 80 may transmit the text data directly to the URL of the storage destination. The speech recognition service system 80 may be selectively switched from among a plurality of services in accordance with setting information set by the user in the information processing system 50.

S73: The upload unit 20 of the information recording app 41 stores the combined moving image in the storage destination of the combined moving image via the communication unit 11. In the recorded video information storage unit 5002, the combined moving image is associated with the conference ID and the recorded video ID. For the combined moving image, “Uploaded” is recorded.

S74: The user performs an operation to end the conference on (inputs an operation to end the conference to) the electronic whiteboard 2. The user may perform an operation to end the conference on the communication terminal 10, and the communication terminal 10 may transmit a conference end notification to the electronic whiteboard 2. In this case, the conference end notification may be transmitted to the electronic whiteboard 2 via the information processing system 50.

S75: The communication unit 36 of the electronic whiteboard 2 designates the conference ID, and transmits the object data (for example, handwritten object data) displayed during the conference to the information processing system 50. The communication unit 36 may transmit the device identification information of the electronic whiteboard 2 to the information processing system 50. In this case, the conference ID is identified by the association information.

S76: Based on the conference ID, the information processing system 50 stores the object data in the same storage destination as the storage destination of the combined moving image and the like.

The user is notified of the storage destination. Thus, the user may notify the participants of the storage destination by email or the like to share the combined moving image with the participants 120. Even if different apparatuses create the combined moving image, the audio data, the text data, and the object data, the combined moving image, the audio data, the text data, and the object data are collectively stored in a single storage place. This makes it easier for the user or the like to view the combined moving image, the audio data, the text data, and the object data later.

The processing of steps S62 to S67 is not necessarily performed in the order described in FIG. 41, and the combination of the audio data and the creation of the combined image may be performed in opposite order.

As described above, the meeting device 60 according to the present embodiment detects a plurality of targets set in advance (such as a face of the participant 120 and a device such as the electronic whiteboard 2), and determines the height and the width of the panoramic image 203 such that the panoramic image 203 includes the targets. Thus, the meeting device 60 successfully generates the panoramic image 203 including the targets.

The above-described embodiment is illustrative and does not limit the present disclosure. Thus, numerous additional modifications and variations are possible in light of the above teachings within the scope of the present disclosure. Any one of the above-described operations may be performed in various other ways, for example, in an order different from the one described above.

For example, the communication terminal 10 and the meeting device 60 may be integrated together. The meeting device 60 may be externally attached to the communication terminal 10. The meeting device 60 may be implemented by a spherical camera, a microphone, and a speaker connected to one another by cables.

The meeting device 60 may be disposed at the second site 101. The meeting device 60 at the second site 101 separately creates a combined moving image and text data. A plurality of meeting devices 60 may be disposed at a single site. In this case, a plurality of pieces of record is created for the respective meeting devices 60.

The arrangement of the panoramic image 203, the talker images 204, and the screen of the app in the combined moving image used in the present embodiment is merely an example. The panoramic image 203 may be displayed below the talker images 204, the user may change the arrangement, or the user may switch between non-display and display individually for the panoramic image 203 and the talker images 204 during playback.

In the configuration examples illustrated in FIG. 9 and the like, the communication terminal 10, the meeting device 60, and the information processing system 50 are each divided in accordance with the major functions thereof to facilitate understanding of the processes performed by the communication terminal 10, the meeting device 60, and the information processing system 50. The way of dividing processing in units or the name of the processing unit do not limit the scope of the present invention. The processes performed by the communication terminal 10, the meeting device 60, and the information processing system 50 may be divided into more processing units in accordance with the content of the processes. In addition, a single processing unit can be further divided into a plurality of processing units.

The apparatuses or devices described in one embodiment are just one example of plural computing environments that implement the one embodiment in this specification. In some embodiments, the information processing system 50 includes multiple computing devices, such as a server cluster. The multiple computing devices are configured to communicate with one another through any type of communication link, including a network, a shared memory, etc., and perform the processes disclosed herein.

Further, the information processing system 50 can be configured to share the processing steps disclosed in the embodiments described above, for example, the processing steps illustrated in FIG. 21, in various combinations. For example, a process executed by a predetermined unit may be executed by a plurality of information processing apparatuses included in the information processing system 50. The components of the information processing system 50 may be integrated into one server apparatus or divided into a plurality of apparatuses.

Any one of the above-described operations may be performed in various other ways, for example, in an order different from the one described above.

Each of the functions of the above-described embodiments may be implemented by one or more pieces of processing circuitry. The term “processing circuit or circuitry” used herein refers to a processor that is programmed to carry out each function by software such as a processor implemented by an electronic circuit, or a device such as an application specific integrated circuit (ASIC), digital signal processor (DSP), field programmable gate array (FPGA), or existing circuit module that is designed to carry out each function described above.

Processors are considered processing circuitry or circuitry as they include transistors and other circuitry therein. In the disclosure, the circuitry, units, or means are hardware that carry out or are programmed to perform the recited functionality. The hardware may be any hardware disclosed herein or otherwise known which is programmed or configured to carry out the recited functionality. When the hardware is a processor which may be considered a type of circuitry, the circuitry, means, or units are a combination of hardware and software, the software being used to configure the hardware and/or processor.

1. An information processing system comprising circuitry configured to:
detect one or more targets preset in a detection setting from a wide-angle image captured by an image-capturing device;
in a case where a plurality of targets is detected from the wide-angle image, generate a first image including the plurality of targets; and
control a communication terminal to display the first image.

2. The information processing system according to claim 1,
wherein the circuitry is configured to, in a case where a part of the plurality of targets has disappeared from the first image, increase a range of the first image so as to include the disappeared part of the plurality of targets.

3. The information processing system according to claim 1,
wherein the circuitry is configured to, in the case where the part of the plurality of targets has disappeared from the first image, increase a height of the first image so as to include the disappeared part of the plurality of targets.

4. The information processing system according to claim 2,
wherein the circuitry is configured to change a dimension of a display area for the first image on the communication terminal such that the first image having an increased area is displayed in the display area.

5. The information processing system according to claim 4,
wherein the circuitry is configured to change the dimension of the display area for the first image in a height direction.

6. The information processing system according to claim 2,
wherein the circuitry is configured to reduce a size of the first image such that the first image having an increased area fits in a display area for the first image on the communication terminal.

7. The information processing system according to claim 1, further comprising the image-capturing device configured to capture the wide-angle image.

8. The information processing system according to claim 1,
wherein the circuitry is configured to generate the first image in which a target among the plurality of targets is arranged at a center of the first image in a horizontal direction.

9. The information processing system according to claim 1,
wherein the circuitry is configured to, in a case where the first image does not include the one or more targets preset in the detection setting, increase a width of the first image such that the first image includes the one or more targets.

10. The information processing system according to claim 1,
wherein the circuitry is configured to, based on a determination that a space between a first target and a second target among the plurality of targets is greater than or equal to a threshold, generate the first image from which an excessive space between the first target and the second target is omitted.

11. The information processing system according to claim 1,
wherein the one or more targets preset in the detection setting includes a face of a person.

12. The information processing system according to claim 1,
wherein the one or more targets preset in the detection setting includes an electronic device.

13. The information processing system according to claim 12,
wherein the circuitry is configured to:
detect a two-dimensional code displayed by an electronic device; and
generate the first image including the electronic device detected based on the two-dimensional code.

14. The information processing system according to claim 12,
wherein the circuitry is configured to:
collect a sound output by the electronic device;
detect a direction from which the sound is collected; and
generate the first image including the electronic device, based on the detected direction of the electronic device.

15. The information processing system according to claim 12,
wherein the circuitry is configured to:
recognize the electronic device through image processing; and
generate the first image including the electronic device recognized.

16. The information processing system according to claim 1,
wherein the circuitry is configured to:
in a case where a display area for the first image on the communication terminal is not set to a fixed value, increase a height of the first image such that the first image includes the plurality of targets; and
in a case where the display area for the first image is set to the fixed value, increase the height of the first image such that the first image includes the plurality of targets, and reduce a size of the first image to fit an initial height set for the display area for the first image while maintaining an aspect ratio of the first image having the increased height.

17. The information processing system according to claim 16,
wherein the circuitry is configured to:
generate a second image representing a person speaking, clipped from the first image;
in the case where the display area for the first image is not set to the fixed value, reduce a height of the second image by an amount by which the height of the first image is increased; and
in the case where the display area for the first image is set to the fixed value, maintain the height of the second image.

18. An image-capturing device comprising circuitry configured to:
capture a wide-angle image; and
in a case where a plurality of targets preset in a detection setting is detected from the wide-angle image, generate a first image including the plurality of targets detected.

19. A display method comprising:
detecting one or more targets preset in a detection setting from a wide-angle image captured by an image-capturing device;
in a case where a plurality of targets preset in a detection setting is detected from the wide-angle image, generating a first image including the plurality of targets; and
controlling a communication terminal to display the first image.
